(19) United States
(12) Patent Application Publication
(10) Pub. No.: US 2025/0385959 A1
(43) Pub. Date: Dec. 18, 2025

(54) ELECTRONIC DEVICE WITH COVER INCLUDING CRACK-RESISTANT PORTION

(71) Applicant: Apple Inc., Cupertino, CA (US)

(72) Inventors: Matthew J. Gutwald, San Francisco, CA (US); Zacharias Vangelatos, Redwood City, CA (US); Lillian Linden, San Diego, CA (US); Andi M. Limarga, Cupertino, CA (US); Christoipher C. Bartlow, Menlo Park, CA (US)

(21) Appl. No.: 19/221,340

(22) Filed: May 28, 2025

Related U.S. Application Data
(60) Provisional application No. 63/659,019, filed on Jun. 12, 2024.
(60) Provisional application No. 63/764,499, filed on Feb. 27, 2025.

(51) Int. Cl. H04M 1/02; C03C 10/00

(52) U.S. Cl. CPC H04M 1/0203; C03C 10/0027; H04M 1/0266

(57) ABSTRACT

An electronic device including a strengthened cover is disclosed. The strengthened cover may include a cover member that includes a crack-resistant portion. The crack-resistant portion of the cover member may be configured to limit formation of a crack, to limit propagation of a crack, or to both limit formation and propagation of a crack within the cover member.

### CROSS-REFERENCE TO RELATED APPLICATION(S)

This application is a nonprovisional application of and claims the benefit of U.S. Provisional Patent Application No. 63/764,499, filed Feb. 27, 2025, and titled “Electronic Device with Cover Including Crack-Resistant Portion,” and U.S. Provisional Patent Application No. 63/659,019, filed Jun. 12, 2024, and titled “Electronic Device with Cover Including Crack-Resistant Portion,” the disclosures of which are hereby incorporated herein by reference in their entirety.

### FIELD

The described embodiments relate generally to electronic devices that include a strengthened cover. More particularly, the present embodiments relate to a cover that is strengthened to provide improved crack-resistance.

### BACKGROUND

Some conventional portable electronic devices include a display that may be protected by a glass cover. Conventional glass covers may be strengthened to provide a substantially uniform internal stress distribution. The electronic devices disclosed herein may provide some advantages compared to some conventional electronic devices with respect to crack-resistance of a particular portion of a cover.

### SUMMARY

Aspects of the following disclosure relate to a cover for an electronic device that is configured to provide resistance to cracking due to impact or another source of stress. The cover may include a glass or glass ceramic cover member that is strengthened at least in part through chemical strengthening. The strengthening techniques described herein can help preserve functionality of the electronic device by limiting cracking within one or more portions of the cover member.

In some embodiments, different portions of the cover member are strengthened differently rather than providing a uniform stress distribution across the cover member. In some cases, the internal stress distribution may be configured to provide one or more portions of the cover member with additional resistance to impact or stress. Alternately or additionally, a portion of the cover member may be strengthened to redirect a crack away from another portion of the cover member. The strengthened portions of the cover member may be formed at least in part by one or more ion exchange operations.

In some embodiments, a portion of a cover member may have an internal stress distribution that is configured to limit formation, growth, and/or propagation of a crack. This portion of the cover member may therefore be referred to as a crack-resistant portion. The compressive stress region, the tensile stress region, or both, of the crack-resistant portion may be configured to provide the crack resistance. When different portions of the cover member are strengthened differently, these different portions of the cover member may have different levels of crack-resistance.

In some embodiments, a crack-resistant portion may provide resistance to crack formation and/or growth. In some cases, the crack-resistant portion may be positioned at a location of the part that may experience impact, excessive stress, non-uniform ion-exchange, or a combination of two or more of these factors. As examples, a crack-resistant portion may be positioned along an edge of the cover member and/or at a base of a camera turret.

Alternately or additionally, a crack-resistant portion may provide a greater resistance to crack propagation than another portion of the cover member. The crack-resistant portion may be used to redirect a crack from a less desirable path to a more desirable path, and therefore may alternately be referred to herein as a crack deflection portion. As examples, the crack-resistant portion(s) may be positioned to deflect a crack away from another portion that is positioned over a display, a camera, a sensor, or the like. In some cases, the cover member includes a strengthened portion having a first internal stress distribution and a crack-resistant portion having a second internal stress distribution that provides greater resistance to crack propagation than the first internal stress distribution.

The disclosure provides an electronic device comprising a display, an optical sensor, and a cover including a cover member comprising a first strengthened portion positioned over at least a portion of the display and having a first internal stress distribution, a second strengthened portion positioned over the optical sensor and having the first internal stress distribution, and a crack-resistant portion positioned between the first and the second strengthened portions and extending from a first region of a perimeter of the cover member to a second region of the perimeter, the crack-resistant portion having a second internal stress distribution that is different from the first internal stress distribution.

The disclosure provides an electronic watch comprising a display and an enclosure at least partially enclosing the display and comprising a housing and a cover coupled to the housing and including a cover member comprising a central region positioned over the display and comprising a first strengthened portion having a first internal stress distribution, a peripheral region defining an edge of the cover member, a transition region extending between the central region and the peripheral region and comprising a third strengthened portion having a third internal stress distribution, and a crack-resistant zone that extends from the edge of the cover member and over a portion of the transition region, the crack-resistant zone having a second internal stress distribution, different from the first internal stress distribution.

The disclosure provides a mobile phone comprising a display, a set of sensors, a housing at least partially enclosing the display and the set of sensors, a front cover coupled to the housing and positioned over the display, and a rear cover coupled to the housing and including a rear cover member comprising a first region defining a first thickness and comprising a first strengthened portion of the rear cover member, the first strengthened portion including a first compressive stress region extending from an exterior surface of the rear cover member, and a second region defining a second thickness, greater than the first thickness, and comprising a second strengthened portion of the rear cover member, the second strengthened portion including a second compressive stress region, different from the first compressive stress region, extending from the exterior surface of the rear cover member, a third region extending between the first region and the second region and including a third strengthened portion of the rear cover member, the third strengthened portion including a third compressive stress region, different from the first compressive stress region, extending from the exterior surface of the rear cover member, and a crack-resistant zone comprising the second strengthened portion and the third strengthened portions of the rear cover member.

The disclosure provides a cover member for an electronic device, the cover member comprising a first strengthened portion defining at least a portion of a display window and having a first internal stress distribution, a second strengthened portion defining a sensor window and having the first internal stress distribution, and a crack-resistant portion extending from a first region of a perimeter of the cover member to a second region of the perimeter and positioned at least in part between the first and the second strengthened portions, the crack-resistant portion having a second internal stress distribution that is different from the first internal stress distribution.

### BRIEF DESCRIPTION OF THE DRAWINGS

The disclosure will be readily understood by the following detailed description in conjunction with the accompanying drawings, wherein like reference numerals designate like elements.

FIG. 1A shows a front perspective view of an example electronic device.

FIG. 1B shows a rear perspective view of the electronic device of FIG. 1A.

FIG. 2A shows a cover member for an electronic device that includes an example crack-resistant portion.

FIG. 2B shows a partial cross-sectional view of the cover member of FIG. 2A.

FIGS. 3A and 3B show examples of compressive stress profiles in different strengthened portions of a cover member.

FIG. 4 shows another cover member for an electronic device that includes another example of a crack-resistant portion.

FIG. 5 shows an electronic device that includes a cover with multiple crack-resistant portions.

FIG. 6 shows another electronic device that includes a cover with multiple crack-resistant portions.

FIG. 7 shows a view of another example electronic device.

FIG. 8 shows a partial cross-section view of an example contoured cover member.

FIG. 9 shows a front view of a contoured cover member that includes multiple crack-resistant zones.

FIG. 10 shows front view of another contoured cover member that includes multiple crack-resistant zones.

FIGS. 11A and 11B show examples of compressive stress profiles and partial tensile stress profiles in different strengthened portions of a cover member.

FIG. 12 shows another example of a cover member for an electronic device.

FIG. 13 shows a partial cross-sectional view of the cover member of FIG. 12.

FIGS. 14A and 14B show examples of compressive stress profiles in different strengthened portions of a cover member.

FIG. 15 shows another cover member for an electronic device that includes differently strengthened portions.

FIGS. 16A and 16B show examples of compressive stress profiles in different strengthened portions of a cover member.

FIGS. 17A and 17B show examples of compressive stress profiles in different strengthened portions of a cover member.

FIGS. 18A and 18B show examples of compressive stress profiles in different strengthened portions of a cover member.

FIG. 19 shows an example of a contoured cover including differently strengthened portions.

FIG. 20 shows an example block diagram of components of an electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

Aspects of the following disclosure relate to a cover for an electronic device that is configured to provide resistance to cracking due to impact or another source of stress. In some embodiments, the cover member of the cover includes at least one strengthened portion that provides resistance to the formation, the enlargement, and/or the propagation of a crack. Therefore, the strengthened portion may be referred to herein as a crack-resistant portion of the cover member.

In some embodiments, different portions of the cover member are strengthened differently to provide crack resistance without creating excessively high levels of tensile stress in the cover member. In some cases, the cover member includes a first strengthened portion having a first compressive stress profile and a second strengthened portion having a second compressive stress profile, different from the first compressive stress profile, which provides resistance to crack formation and/or growth within the second strengthened portion. The second compressive profile may provide greater resistance to crack formation and/or growth within the second strengthened portion than the first compressive stress profile provides within the first strengthened portion, as discussed in more detail below.

In some embodiments, the cover member includes a strengthened portion that has a greater resistance to propagation of a crack than another strengthened portion of the cover member. In some cases, the crack-resistant portion(s) may redirect a crack away from another portion of the cover member, such as a crack-sensitive portion of the cover member. In some cases, the crack-sensitive portion of the cover member defines a window for one or more optical components of the electronic device. As examples, the cover member may define one or more of a sensor window for an optical sensor, a display window for a display, or the like. For example, this crack-resistant portion may have an internal stress distribution that is configured to limit propagation of the crack as compared to the internal stress distribution of another strengthened portion of the cover member, as discussed in more detail below. In embodiments, the optical appearance of the differently strengthened regions may be substantially uniform. For example, one or more optical properties such as the transmissivity, clarity, or the haze may be substantially uniform across the differently strengthened regions.

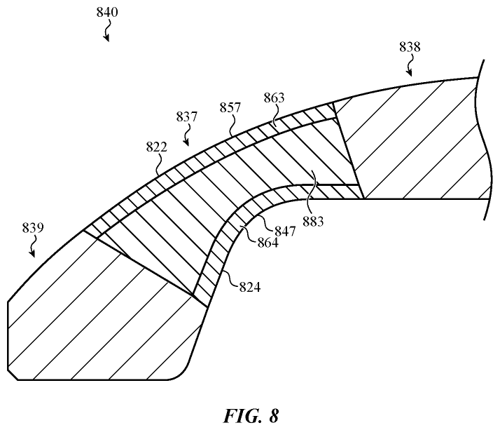

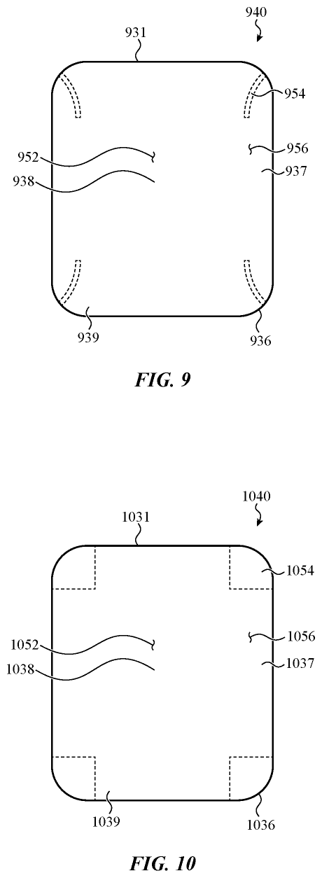

The cover member may be formed of an ion-exchangeable material such as a glass or a glass ceramic material and the strengthened portions of the cover member may be formed at least in part by one or more ion exchange operations. The ion-exchangeable material may be an aluminosilicate material, such as an alkali aluminosilicate material. Following the ion-exchange operation(s), a given strengthened portion of the cover member may include compressive stress regions extending from exterior and interior surfaces of the cover member. In some cases, a strengthened portion of the cover may include a compressive stress region extending from a side surface of the cover member. Each of these compressive stress regions may define a respective compressive stress profile. A tensile stress region may also be created to balance the stresses in the cover member. The internal stress distribution for a given strengthened portion includes these compressive stress and tensile stress regions. In some cases, the cover member may define a crack-resistant zone that includes one or more crack-resistant portions, as described in more detail with respect to the examples of FIGS. 9, 10, and 12.

The internal stress distribution of a crack-resistant portion typically differs from that of another strengthened portion of the cover member. The compressive stress region, the tensile stress region, or both, of the crack-resistant portion may be configured to provide improved crack resistance as compared to the other strengthened portion, as described in more detail below. In some examples, a compressive stress region of the crack-resistant portion may be configured to provide improved resistance to one or more of crack initiation, crack enlargement, and crack propagation. In further examples, a tensile stress region of the crack-resistant portion may be configured to retard to crack propagation.

In some embodiments, the crack-resistant portion may provide a greater resistance to crack formation than another portion of the cover member. The crack-resistant portion(s) may be positioned at locations of the part that are susceptible to cracking due to damage introduction, excessive stress, non-uniform ion-exchange, or a combination of two or more of these factors. As examples, damage introduction or excessive stress may result from impact (e.g., from the device being dropped) or from another source of mechanical stress. In some cases, the crack-resistant portion may be positioned along an edge of the cover member and/or at a base of a camera turret.

In some cases, the cover member includes a strengthened portion having a first compressive stress profile and a crack-resistant portion having a second compressive stress profile that provides greater resistance to crack formation than the first compressive stress profile. In some cases, the second compressive stress profile of the crack-resistant portion may have one or more of a greater compressive stress profile integral, a greater surface compressive stress, a greater depth of compression, a greater compressive stress at a profile transition, or a greater depth at the profile transition.

In some embodiments, the crack-resistant portion may provide a greater resistance to crack propagation than another strengthened portion of the cover member. The crack-resistant portion may be used to redirect a crack from a less desirable path to a more desirable path, and therefore may alternately be referred to herein as a crack deflection portion. As examples, the crack-resistant portion(s) may be positioned to deflect a crack away from another portion that is positioned over a display, a camera, a sensor, or the like.

For a crack extends that extends into the cover member, the propagation of the crack in a given strengthened portion may be influenced by the internal stress distribution in the strengthened portion, as well as any external sources of mechanical stress. In some cases, each of the compressive stress regions and the tensile stress region may have some influence on the crack propagation. For example, the compressive regions may act to retard crack propagation near the surfaces of the cover member. The tensile regions may act to drive crack propagation.

In some embodiments, the cover member includes a strengthened portion having a first internal stress distribution and a crack-resistant portion having a second internal stress distribution that provides greater resistance to crack propagation than the first compressive stress profile. In some cases, the second compressive stress profile of the crack-resistant portion may be configured to provide a greater resistance to crack propagation as compared to the first compressive stress profile. As examples, the second compressive stress profile of the crack-resistant portion may have one or more of a greater compressive stress profile integral, a greater surface compressive stress, a greater depth of compression, a greater compressive stress at a profile transition, a greater depth at the profile transition, or a greater compressive stress at a depth other than the depth of the profile transition. In some examples, the second compressive stress profile may be referred to as defining a second parameter (e.g., a second depth at the profile transition) that differs from a first parameter (e.g., a first depth at the profile transition) of the first compressive stress profile. The second internal stress distribution may be configured so that the increase in crack retarding effect provided by the compressive stress regions outweighs any increase in the driving force for crack propagation provided by the tensile stress region. To limit the amount of tensile stress created in the cover member as a whole, it may also be desirable to limit the volume of the portion(s) having the second compressive stress profile rather than providing this compressive stress profile throughout the cover member. A crack-resistant portion may alternately be referred to herein as a crack-resistant zone, for example when the crack-resistant zone extends over multiple regions and/or portions of the cover member.

In some cases, the second tensile stress profile of the crack-resistant portion may be configured to retard crack propagation as compared to the first tensile stress profile. As examples, the propagation of the crack in a given portion may be limited by reducing one or more of the tensile stress profile integral, the peak tensile stress, or the central tension of the crack-resistant portion as compared to an adjacent portion, thereby reducing the crack driving effect of the tensile region. The compressive stress regions in the crack-resistant portion may have a lesser amount of integrated compressive stress and may therefore have less of a retarding effect on both formation of a through crack and propagation of the through crack. The second internal stress distribution may be configured so that the reduced driving force for crack propagation provided by the tensile stress region outweighs any reduction in the amount of crack retardation provided by the compressive stress regions.

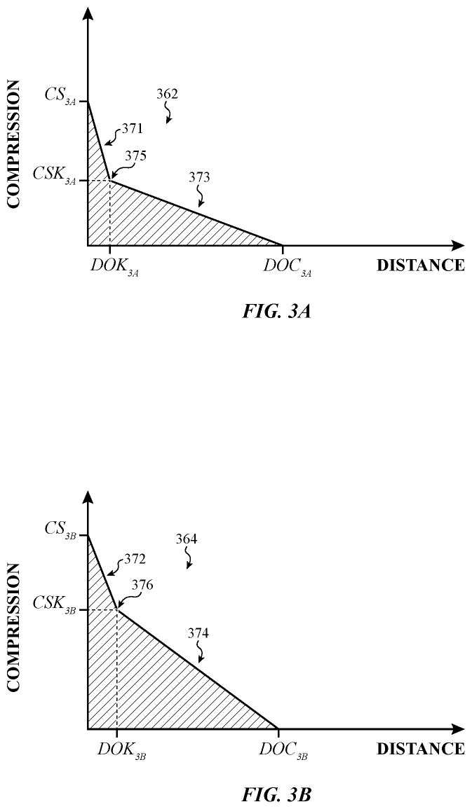

Differently strengthened portions of the cover member may be produced by a variety of techniques. For example, the differently strengthened portions of the cover may be subjected to a different number of ion exchange operations. Alternately or additionally, the differently strengthened portions of the cover may be subjected to different thermal treatments, so that the differently strengthened portions have a different thermal history. A given thermal treatment may take place before or after a given ion exchange operation. Additional description of ion exchange operations and thermal treatments is provided below with respect to FIG. 3A through 18B.

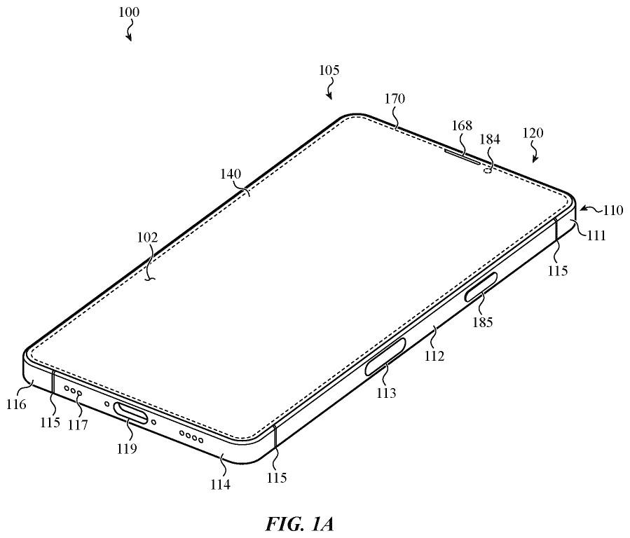

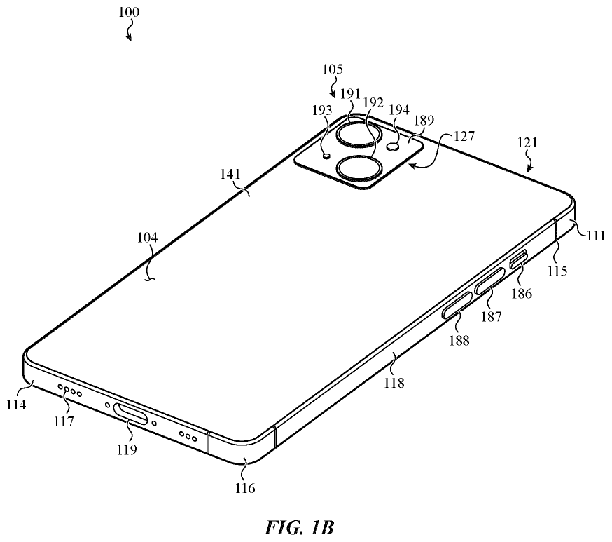

These and other embodiments are discussed below with reference to FIGS. 1A-20. However, those skilled in the art will readily appreciate that the detailed description given herein with respect to these figures is for explanatory purposes only and should not be construed as limiting.

FIG. 1A shows a front perspective view and FIG. 1B shows a rear perspective view of an example electronic device 100. The electronic device 100 may be a mobile telephone (also referred to as a mobile phone). In other examples, the electronic device may have the form of a tablet computer, a laptop computer, a display monitor, a wearable electronic device (e.g., a smart watch or a headset), or another form of electronic device.

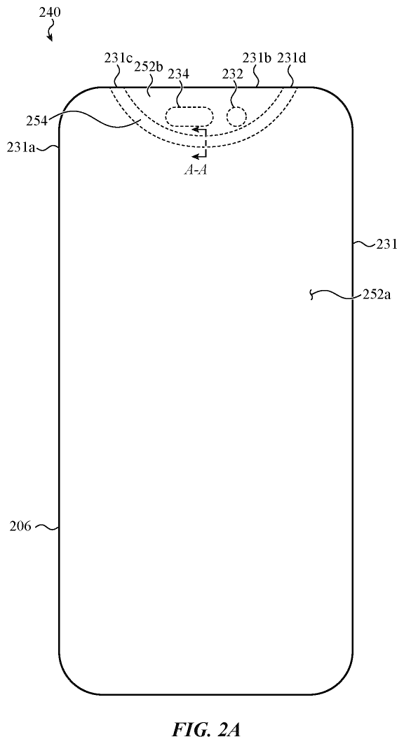

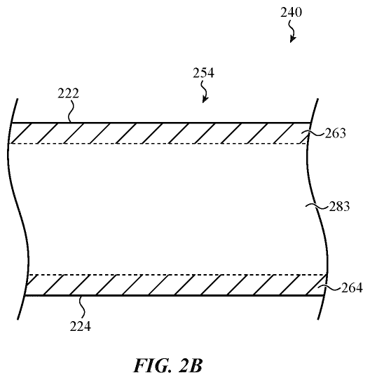

The electronic device 100 includes an enclosure 105. The enclosure 105 includes a housing 110, a front cover 120, and a rear cover 121. A cover member included in at least one of the front cover 120 and the rear cover 121 may include a crack-resistant portion that is configured to limit formation and/or propagation of a crack. In some cases, the crack-resistant portion can help to preserve functionality of the electronic device by deflecting a crack away from a crack-sensitive portion of the cover member (e.g., a portion positioned over an optical component such as a camera, a sensor, or a display). Examples of such crack-resistant portions are shown at least in FIGS. 2A, 4, 5, and 6.

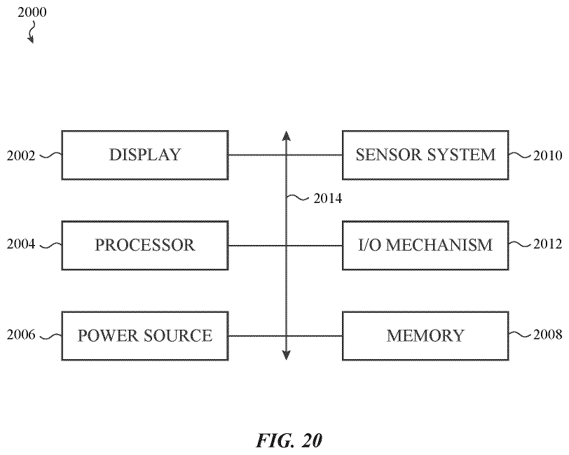

The enclosure 105 defines an internal cavity into which one or more device components is placed. Therefore, the enclosure 105 at least partially encloses one or more device components. The electronic device 100 includes a display assembly 170 and a rear sensor assembly 189. The electronic device 100 also includes a front-facing camera and/or a front-facing biometric sensor 184, which may be an optical sensor, and/or all or some of the other device components described with respect to FIG. 20. For example, the electronic device may include one or more of a display assembly, a processor, a power source, a sensor system (e.g., an optical sensor system), an input/output mechanism, a wireless communication or charging component, or a memory. The electronic device may also include electronic circuitry operably connected to the device components.

As shown in the example of FIG. 1A, the front cover 120 is positioned over the display assembly 170. The display assembly may include a touch sensitive layer and may alternately be referred to as a touch-sensitive display or a touchscreen. In some embodiments, the display assembly is an organic light-emitting diode (OLED) display assembly or an active layer organic light-emitting diode (AMOLED) display assembly. In other embodiments, the display assembly is a liquid-crystal (LCD) assembly, a light-emitting diode (LED) display assembly, or an LED-backlit LCD display assembly.

The front cover 120 defines at least a portion of a front surface 102 of the electronic device. The front cover 120 defines an opening 168, which may allow input to a microphone or another device component. The front cover 120 includes a cover member 140. In some examples, the front cover 120 and the cover member 140 may each define four corner regions. The front cover 120 may also include a surface coating disposed over an exterior surface of the cover member 140, such as an anti-reflective coating and/or an anti-smudge (e.g., oleophobic) coating. The front cover 120 may also include a coating disposed over an interior surface of the cover member 140. As examples, this interior coating may provide a decorative effect and/or provide a masking function. In some examples, the front cover 120 may define a substantial entirety and/or substantially all of the front surface of the electronic device.

The cover member 140 may define a window over an optical component of the electronic device. In some examples, the cover member 140 may define one or more of a sensor window for an optical sensor, a display window for a display, or a like. The optical sensor may include an image sensor and may be part of a sensor assembly, such as a camera assembly, a biometric sensor assembly, or the like. The sensor may sense one or more of visible light, infrared (IR) light, or ultraviolet (UV) light).

The cover member 140 may include an ion-exchangeable material, such as a glass material or a glass ceramic material. In some embodiments, the cover member 140 is a glass cover member that is formed of a silicate glass material. In other embodiments, the cover member 140 may be formed of a glass ceramic material or may have a laminate structure that includes one or more layers of a glass material, a glass ceramic, and/or a polymer material. In some cases, an exterior layer of a laminate structure may be formed of a glass and/or glass ceramic material while in other cases the exterior layer of the laminate structure may be formed of a polymer material. The glass or glass ceramic material may be an aluminosilicate material, such as an alkali aluminosilicate material (e.g., an aluminosilicate material comprising lithium ions). The cover member may have a thickness suited to the electronic device, and in some cases may have a thickness greater than 500 micrometers to 5 mm, from 400 micrometers to 3 mm, or from 200 micrometers to 1 mm.

As shown in the example of FIG. 1B, the electronic device 100 includes a set of rear sensors 189. The set of rear sensors 189 include multiple cameras 191 and 192. The electronic device 100 includes components 193 and 194, which may be a light source, a sensor such as a depth sensor, or any other suitable component. At least a portion of the rear sensor assembly is positioned under the rear cover 121. The example of FIG. 1B is not limiting and in additional examples the electronic device may include a greater or a lesser number of rear sensors.

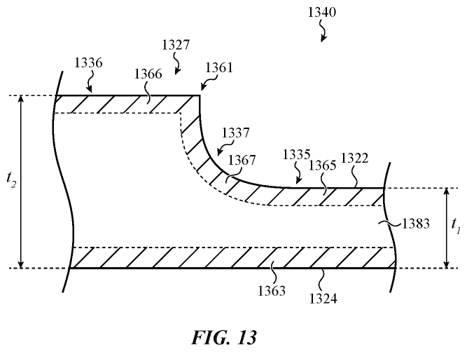

The rear cover 121 defines at least a portion of a rear surface 104 of the electronic device. In some examples, the rear cover 121 may define a substantial entirety and/or substantially all of the rear surface of the electronic device. The rear cover 121 includes a cover member 141. In the example of FIG. 1B, the rear cover 121 defines a protruding portion 127 at the location of the rear sensor assembly 189. The protruding portion 127 may alternately be referred to herein as a protruding feature and may define one or more openings. In some examples, one or more components of the set of rear sensors and/or other components of the electronic device extend at least partially through an opening of a set of openings. As an example, the protruding portion 127 may define a camera turret. In some examples the cover member 141 defines the protruding portion 127, as described in more detail with respect to FIG. 13. In other examples, the protruding portion 127 may be defined by multiple cover members, one of which is the cover member 141. In some examples, the rear cover 121 and the cover member 141 may each define four corner regions.

The rear cover 121 may also include a surface coating disposed over an exterior surface of the cover member 141, such as an anti-reflective coating and/or an anti-smudge (e.g., oleophobic) coating. The rear cover 121 may also include a coating disposed over an interior surface of the cover member 141. As examples, this interior coating may provide a decorative effect and/or provide a masking function.

The cover member 141 may include or be formed of an ion-exchangeable material, such as a glass material or a glass ceramic material. In some embodiments, the cover member 141 is a glass cover member that is formed of a silicate glass material. In some cases, the silicate glass material may include a coloring agent. In other embodiments, the cover member 141 may be formed of a glass ceramic material or may have a laminate structure that includes one or more layers of a glass material, a glass ceramic, and/or a polymer material. The glass or glass ceramic material may be an aluminosilicate material, such as an alkali aluminosilicate material (e.g., an aluminosilicate material comprising lithium ions). The cover member may have a thickness suited to the electronic device, and in some cases may have a thickness greater than 500 micrometers to 5 mm, from 400 micrometers to 3 mm, or from 200 micrometers to 1 mm.

The front cover 120 and rear cover 121 may define any of a variety of surface textures. In other examples, the rear cover 121 may have a texture that has a higher amplitude (alternately, height), about the same amplitude, and/or a lower amplitude than the anti-glare texture of the front cover 120. In some cases, the rear cover 121 may have a combination of surface textures.

The housing 110 of the electronic device 100 is coupled to each of the front cover 120 and the rear cover 121. The housing 110 includes input devices 185, 186, 187, and 188. In the example of FIGS. 1A and 1B, each of the input devices may be a push button, a touch-activated button, or the like. The example of FIGS. 1A and 1B is not limiting and in other examples, the electronic device 100 may include an input device in the form of a dial, a crown, a wheel, or the like. The housing 110 also includes a window 113 that may facilitate transmission of a wireless communication signal. The housing 110 also defines openings to facilitate input to the electronic device. The openings 117 may allow input to a microphone and/or may allow output from a speaker. The opening 119 may define a port.

In the example of FIGS. 1A and 1B, the housing 110 is formed from multiple members, such as the members 111, 112, 114, 116, and 118. In some embodiments, the members 111, 112, 114, 116, and 118 are metal members that are separated by dielectric members 115 (e.g., polymer or polymer composite members). The dielectric members can provide electrical isolation between adjacent metal members. One or more of the metal members may be coupled to internal circuitry of the electronic device 100 and may function as an antenna for sending and receiving wireless communication.

FIG. 2A shows a cover member for an electronic device that includes a crack-resistant portion. The cover member 240 may be a front cover member of an electronic device that is positioned over one or more of a display, a camera, and a set of sensors. The set of sensors may include one or more optical sensors, such as an optical biometric sensor. A camera region 232 of the cover member 240 may be positioned over the camera and a sensor region 234 of the cover member 240 may be positioned over the set of sensors. The camera region 232 may alternately be referred to herein as a camera window or a sensor window (for the optical sensor of the camera). The sensor region 234 may alternately be referred to as a sensor window. In some embodiments, the cover member 240 may define a single sensor window while in other embodiments, the cover member 240 may define multiple sensor windows, which may be numbered accordingly. The camera region 232 and the sensor region 234 are shown with dashed lines in FIG. 2A. In additional examples, the cover member may define an opening over the camera and/or a sensor and the opening may define the camera region 232 and/or the sensor region 234. The cover member 240 also defines a window for the display (alternately, a display window). The example of FIG. 2A is not intended to be limiting and in other examples the device need not include a display, may only include one of the camera region 232 and the sensor region 234, or may include a greater number of camera and/or sensor regions. The device may further include any of the components described with respect to FIGS. 1A, 1B, and 20.

The cover member 240 includes three strengthened portions, a first strengthened portion 252a, a second strengthened portion 252b and a crack-resistant portion 254. The boundaries of the crack-resistant portion 254 are shown with dashed lines. The crack-resistant portion 254 may be configured to provide a greater resistance to propagation of a crack than the strengthened portions 252a and 252b. The crack-portion may additionally provide greater resistance to initiation of a crack than the strengthened portions 252a and 252b. The first strengthened portion 252a is positioned over most of the display and defines at least a portion of a display window. The second strengthened portion 252b includes the camera region 232 and the sensor region 234 and defines a window for a camera and a sensor in the example of FIG. 2A. In other examples, a second strengthened portion may define a window over a single optical component or over more than two optical components. The first strengthened portion 252a and the second strengthened portion 252b may have the same or a similar internal stress profile. The two strengthened portions 252a and 252b may be considered to form a zone, which may be referred to herein as a primary zone. The first and second strengthened portions may alternately be referred to herein as first portion 252a and second portion 252b. The cover member 240 defines a side surface 206 (alternately, an edge), which in turn defines a perimeter 231.

The first and strengthened portions 252a and 252b and the crack-resistant portion 254 may be formed at least in part by one or more ion exchange operations. Following the ion-exchange operation(s), each of the first and strengthened portions 252a and 252b and the crack-resistant portion 254 may include compressive stress regions extending from the exterior and interior surfaces of the cover member, as shown in the example of FIG. 2B. Each of these compressive stress regions may define a respective compressive stress profile. A tensile stress region is created between these compressive stress regions to balance the stresses in the cover member. The tensile stress region may define a tensile stress profile. The internal stress distribution includes the compressive stress and tensile stress regions. An internal stress distribution may alternately be referred to herein as an internal stress pattern or an internal stress profile.

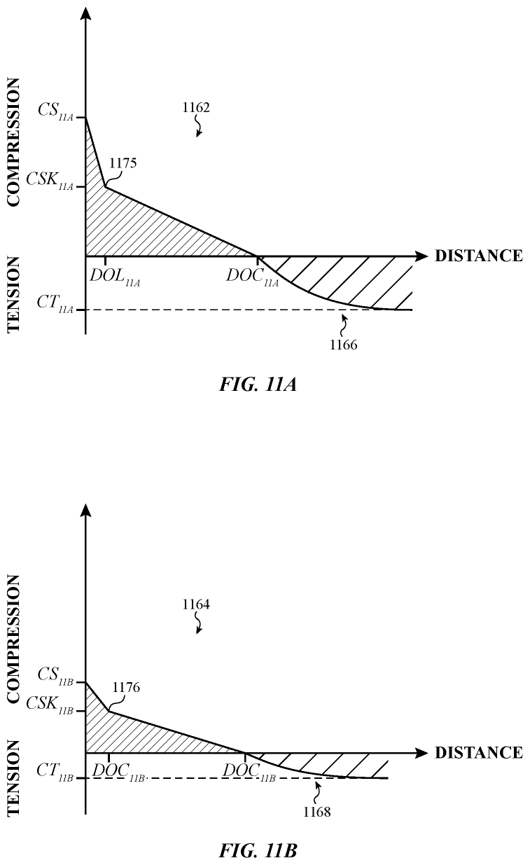

The second internal stress distribution of the crack-resistant portion 254 differs from the first internal stress distribution of the first strengthened portion 252a in order to achieve deflection of a propagating crack. In some embodiments, the crack-resistant portion 254 has a compressive stress profile that produces slower propagation of a crack as compared to the first strengthened portion 252a, as discussed in more detail with respect to FIGS. 3A and 3B. In other embodiments, the crack-resistant portion 254 has a tensile stress profile that produces slower propagation of the crack as compared to the first strengthened portion 252a, as discussed in more detail with respect to FIGS. 11A and 11B.

The configuration of the crack-resistant portion 254 shown in FIG. 2A may divert a crack approaching the camera region 232 and the sensor region 234 and can therefore help to preserve functionality of a camera and/or a set of sensors underlying the cover member 240. In some cases, the crack-resistant portion 254 may deflect a crack approaching the crack-resistant portion from the first strengthened portion 252a. In the example of FIG. 2A, the crack-resistant portion 254 partially surrounds the camera region 232 and the sensor region 234 of the cover member 240 and extends to the perimeter 231 of the cover member 240. The crack-resistant portion 254 is substantially continuous. As shown in FIG. 2A, the crack-resistant portion 254 curves around the camera region 232 and the sensor region 234. In some embodiments, the crack-resistant portion 254 has a width from 1 mm to 10 mm.

The crack-resistant portion is positioned between the strengthened portions 252a and 252b. The crack-resistant portion 254 may thus be viewed as dividing the primary strengthened zone into two portions; the smaller portion 252b that includes the camera region 232 and the sensor region 234 and the larger portion 252a that is positioned over most of the display. Each of strengthened portions 252a and 252b defines a respective portion of the perimeter 231. As an example, crack-resistant portion 254 may define a first region 231c and a second region 231d of the perimeter 231, the strengthened portion 252a may define a third region 231a of the perimeter 231 and the strengthened portion 252b may define a fourth region 231b of the perimeter.

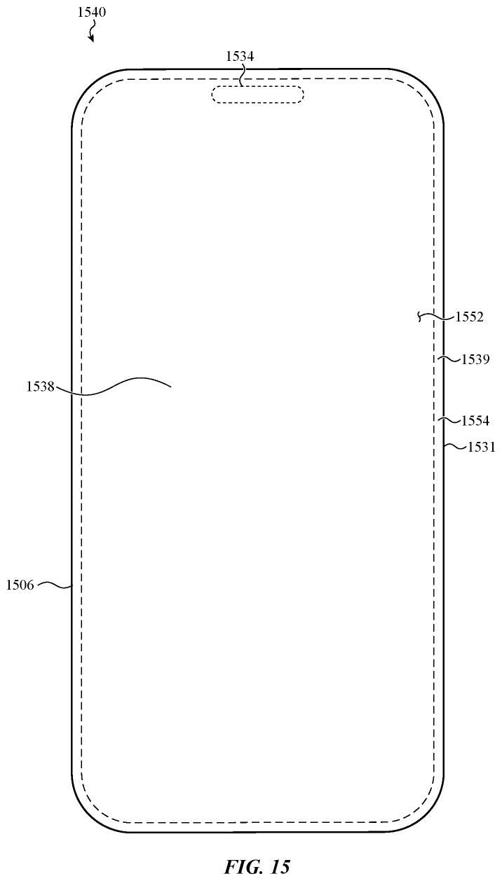

In the example of FIG. 2A, the strengthened portions 252a and 252b and the crack-resistant portion 254 are shown as defining an entirety of the cover member 240. However, this example is not limiting and in other examples, a crack-resistant portion or an additional crack-resistant portion may extend around a perimeter of the cover member in a similar manner as the crack-resistant portion 1554 of FIG. 15. When the crack-resistant portion extends around an entirety of the perimeter, a first region of the crack-resistant portion may be positioned between the first and the second strengthened portions and a second region of the crack-resistant portion may extend around a remainder of the perimeter of the cover member. When a second crack-resistant portion is present that extends around an entirety of the perimeter of the cover member, the first crack-resistant portion 254 may extend from the second crack-resistant portion to partially surround the camera region 232 and the sensor region 234 of the cover member 240.

In some embodiments, the strengthened portions of the cover member may be formed by a process that includes one or more ion exchange operations. The process typically includes at least one operation in which smaller ions in the ion-exchangeable material of the cover member are exchanged for larger ions in order to create a compressive stress layer. For example, if the ion-exchangeable material comprises sodium ions, the sodium ions may be exchanged for potassium ions. Similarly, if the ion-exchangeable material comprises lithium ions, the lithium ions may be exchanged for sodium ions and/or potassium ions. In some embodiments, the process may further include an operation of exchanging larger ions which have been introduced into the glass with smaller ions. For example, if an ion-exchangeable material includes potassium ions and sodium ions that have been introduced by ion exchange, a subsequent ion exchange operation may exchange at least some of these potassium ions with sodium ions. The ion exchange operations may take place at a temperature below a strain point of the ion-exchangeable material. The one or more ion exchange operations typically form an ion-exchanged region, and the compressive stress layer is formed within the ion-exchanged region.

In some embodiments, a process for forming a strengthened cover including a crack-resistant portion comprises applying a mask to the cover member prior to performing an ion exchange operation. Typically, the mask exposes one or more areas of the cover member while covering others. The mask is configured to reduce the rate of ion exchange through the mask as compared to the rate of ion exchange at the exposed areas of the cover member. The mask may be formed of a patterned coating of a metal, an oxide material (e.g., silicon oxide), or a nitride material (e.g., silicon nitride). In some examples, the process may include an ion exchange operation in which the entire cover member may be exposed to an ion exchange medium, an operation of applying a mask, an additional ion-exchange operation in which unmasked portions of the cover member are subjected to additional ion exchange, and an operation of removing the mask from the cover member.

The composition of the cover member prior to any ion exchange operation is referred to herein as the native composition of the cover member, such as a native glass composition or a native glass ceramic composition. An ion exchange operation may be conducted using an ion exchange medium such as a bath or other medium which comprises one or more ions to be exchanged with ions in the cover member. Other types of ion exchange media include pastes, which may include higher concentrations of sources of the ions to be introduced into the cover member than an ion exchange bath. As an example, the ion source may comprise one or more of lithium, sodium, and potassium ions. The ion-exchange operation typically occurs at temperatures above ambient temperature.

The cover member 240 may be similar in composition and dimensions to the cover member 140 and that description is not repeated here. The cover member 240 may be included in a cover of the electronic device, which may be similar to the front cover 120 or the rear cover 121. In some examples, the cover may be included in a front cover of the electronic device. The cover may be coupled to a housing. In some cases, the cover also includes an interior coating disposed on a peripheral portion of the cover member 240. The interior coating may act as a mask to obscure some components positioned within an interior of the enclosure.

FIG. 2B shows a partial cross-sectional view of the cover member of FIG. 2A. The view of FIG. 2B shows compressive stress regions in the crack-resistant portion 254 of the cover member 240. The view of FIG. 2B may be an example cross-sectional view of the crack-resistant portion 254 along line A-A in FIG. 2A.

In the example of FIG. 2B, the crack-resistant portion 254 includes a compressive stress region 263 extending from the exterior surface 222 of cover member 240 and a compressive stress region 264 extending from the interior surface 224 of cover member 240. A tensile stress region 283 is positioned between the compressive stress region 263 and the compressive stress region 264. The boundaries of the compressive stress regions 263 and 264 are shown with dashed lines. The compressive stress region 263 may alternately be referred to herein as an exterior compressive stress region and the compressive stress region 264 may alternately be referred to herein as an interior compressive stress region. The cover member 240 may also have a compressive stress region extending from its side surface 206 (alternately referred to as a side compressive stress region) in the crack-resistant portion 254.

In embodiments, the strengthened portions 252a and 252b also include exterior and interior compressive stress regions and an intermediate tensile stress region. However, the exterior compressive stress region, the interior compressive stress region, and/or the intermediate tensile stress region in the strengthened portions 252a and 252b typically differ from the exterior compressive stress region, the interior compressive stress region, and/or the intermediate tensile stress region in the crack-resistant region. Examples of differences in compressive stress profiles of the crack-resistant portion of a cover member and another strengthened portion of the cover member are shown and described with respect to FIGS. 3A and 3B. The cover member 240 may also have a compressive stress region extending from its side surface 206 in the strengthened portions 252a and 252b.

FIGS. 3A and 3B show examples of compressive stress profiles in different strengthened portions of a cover member. The compressive stress profiles of FIGS. 3A and 3B may be examples of the compressive stress profiles in the cover member of FIG. 2A or of other strengthened cover members described herein. In some embodiments, the internal stress distribution of FIG. 3B may be obtained by forming an internal stress distribution similar to that of FIG. 3A and then performing an additional ion exchange operation, as described in more detail below.

FIG. 3A shows an example of a compressive stress profile in a strengthened portion of the cover member. The compressive stress profile 362 may be an example of the compressive stress profile in the strengthened portion 252a of FIG. 2A. The compressive stress profile 362 has a surface compressive stress CS_{3A} and a depth of compression DOC_{3A}. The compressive stress profile 362 also defines a slope transition 375 (which may be alternately referred to as a “knee” or as an inflection point) at a compressive stress CSK_{3A} and a depth DOK_{3A}. The slope transition 375 divides the compressive stress profile 362 into a first portion 371 that extends from the surface of the cover member and a second portion 373 that extends from the transition 375 to the depth of compression DOC_{3A}. The first portion 371 may alternately be referred to herein as a surface portion and the second portion 373 may alternately be referred to herein as a core portion. When the strengthened potion is a first strengthened portion of the cover member, the surface portion may be referred to a first surface portion and the core portion may be referred to as a first core portion. An integral of a stress profile (or a portion of the stress profile) may be alternately referred to herein as a profile integral of that stress profile (or the portion of the stress profile).

FIG. 3B shows another example of a compressive stress profile in another portion of the cover member that has greater crack-resistance than the strengthened portion of FIG. 3A. This portion of the cover member may therefore be referred to as a crack-resistant portion. The compressive stress profile 364 may be an example of the compressive stress profile in the crack-resistant portion 254 of FIG. 2A. The compressive stress profile 364 has a surface compressive stress CS_{3B} and a depth of compression DOC_{3B}. The compressive stress profile 364 also defines a slope transition 376 (which may be alternately referred to as a “knee” or as an inflection point) at a compressive stress CSK_{3B} and a depth DOK_{3B}. The slope transition 376 divides the compressive stress profile 364 into a first portion 372 that extends from the surface of the cover member and a second portion 374 that extends from the transition 376 to the depth of compression DOC_{3B}. The first portion 372 may alternately be referred to herein as a surface portion and the second portion 374 may alternately be referred to herein as a core portion. When the other strengthened potion is a second strengthened portion of the cover member, the surface portion may be referred to a second surface portion and the core portion may be referred to as a second core portion.

As shown in FIGS. 3A and 3B, the compressive stress profile 364 of the crack-resistant strengthened portion is different from the compressive stress profile 362 of the other strengthened portion. Several of these differences can contribute to the greater crack-resistance provided by the compressive stress profile 364 as compared to the compressive stress profile 362. As an example, an integral of the compressive stress profile 364 of the crack-resistant portion may be greater than an integral of the compressive stress profile 362 of the other strengthened portion. The greater compressive stress profile integral of the compressive stress profile 364 may help retard propagation of a crack through the compressive stress region(s) of the crack-resistant portion of the cover member. The compressive stress profile 364 of the crack-resistant portion has a surface compressive stress CS_{3B} that may be greater than the surface compressive stress CS_{3A} of the compressive stress profile 362 of the other strengthened portion in order to provide a greater compressive stress profile integral. In the example of FIGS. 3A and 3B, the depth of compression DOC_{3B} of the crack-resistant portion is not substantially greater than the depth of compression DOC_{3A} of the other strengthened portion. The compressive stress profiles shown in FIGS. 3A and 3B are exemplary rather than limiting. and in other examples a different compressive stress profile may be used to provide crack resistance. As examples, the depth of compression of a crack-resistant portion may be greater than the depth of compression of another strengthened portion and/or the relative surface compressive stresses may be different than shown in FIGS. 3A and 3B.

As another example, the greater integral of the surface portion 372 of the compressive stress profile 364 of the crack-resistant portion as compared to the integral of the surface portion 371 of the compressive stress profile 362 of the other strengthened portion may help retard propagation of a crack near the surface of the crack-resistant portion of the cover member. In some cases, a greater compressive stress CSK_{3B} at the transition 376 of the crack-resistant portion as compared to the CSK_{3A} at the transition 375 of the other strengthened portion may be related to greater retardation of crack propagation, especially when the depth DOK_{3B} at the transition 376 of the crack-resistant portion is greater than or equal to the depth DOK_{3A} at the transition 375 of the other strengthened portion. In some examples, the difference in the compressive stress at the transitions (e.g., 376, 375) in the compressive stress profile may be from 10 MPa to 50 MPa or from 20 MPa to 80 MPa.

As previously discussed, the complete internal stress distribution typically includes a tensile stress profile in addition to the compressive stress profile(s). The greater integral of compressive stress in the surface portion 372 of the stress profile 364 of the crack-resistant portion may be associated with a greater integral of tensile stress. The second internal stress distribution may be configured so that the increase in crack retarding effect provided by the compressive stress regions outweighs any increase in the driving force for crack propagation provided by the tensile stress region. Therefore, the compressive stress profile 364 may be configured so that the increase in the crack retarding effect provided by the compressive stress regions outweighs any increase in the driving force for crack propagation provided by the compressive stress regions.

For simplicity of illustration, FIGS. 3A and 3B do not show the tensile stress profile of the internal stress distribution. However, FIGS. 11A and 11B provide some examples of compressive stress profiles in combination with a portion of the tensile stress profile. In some embodiments, the compressive stress regions of the cover member are substantially symmetric, so that the compressive stress profiles are similar at the exterior and interior surfaces of the cover member. In this case, the internal stress distribution may also be symmetric. In other embodiments, the internal stress distribution may be asymmetric. For example, the compressive stress profile integral may have a greater value for the compressive stress profile extending from the exterior surface as compared to the compressive stress profile extending from the interior surface of the cover member.

In some embodiments, different internal stress distributions in different portions of a cover member may be obtained at least in part through selective ion exchange. For example, a process for chemically strengthening the cover member may include an operation in which only selected portions of the cover member are exposed to an ion-exchange medium. The cover member may be selectively exposed to the additional ion-exchange medium by masking other portions of the cover member or by selectively applying the ion-exchange medium. Alternately or additionally, the cover member may be selectively exposed to a source of energy to enhance the ion-exchange. In examples where only selected portions of the cover member are exposed to the ion exchange medium, heating of other portions of the cover member may modify the internal stress profile of the other portions (e.g., by additional diffusion of ions within the cover member). The description of forming different internal stress profiles at least in part through selective ion exchange provided herein is not limited to the examples of FIGS. 3A and 3B but is generally applicable to strengthened cover members described herein.

With respect to the example of FIGS. 3A and 3B, the internal stress distribution of FIG. 3A may be obtained by providing an ion-exchangeable cover member including lithium ions and then performing one or more ion-exchange operations in which lithium ions in the glass are exchanged for sodium ions and/or potassium ions from an ion-exchange medium. The entire surface of the cover member may be exposed to the ion-exchange medium during these one or more ion-exchange operations. The internal stress distribution of FIG. 3B may be obtained through an additional ion exchange operation in which a portion of the cover member is selectively exposed to an additional ion-exchange medium. The additional ion operation may be an operation in which additional sodium and/or potassium ions are introduced into the cover member from the additional ion-exchange medium. The additional potassium and sodium ions can increase the surface compressive stress and the knee compressive stress as well as the knee depth.

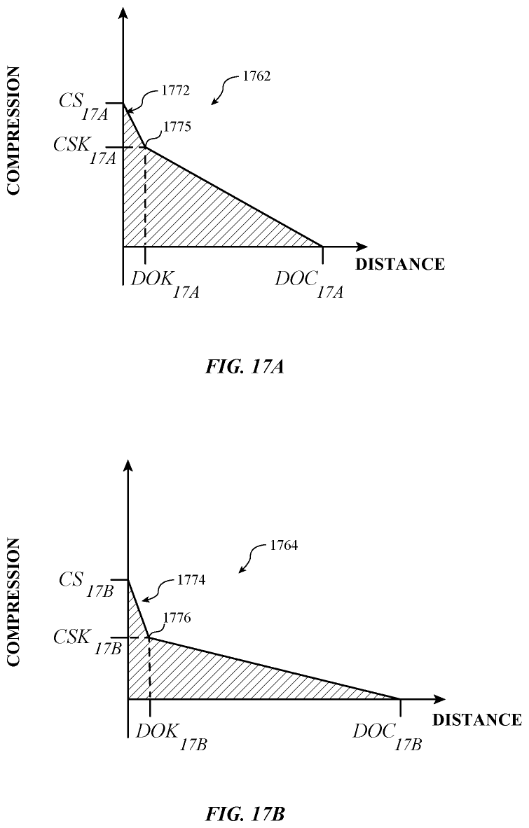

Alternately or additionally, different internal stress distributions in different portions of a cover member may be obtained by using one or more thermal treatment operations in combination with one or more ion exchange operations. In some examples, the thermal treatment operation may occur after an ion exchange operation and may be used to modify the internal stress distribution within a strengthened portion of the cover member. Examples of use of a thermal treatment operation to modify a strengthened portion of a cover member are described in more detail with respect to FIGS. 15, 17A, and 17B and the additional description provided with respect to these figures is generally applicable herein.

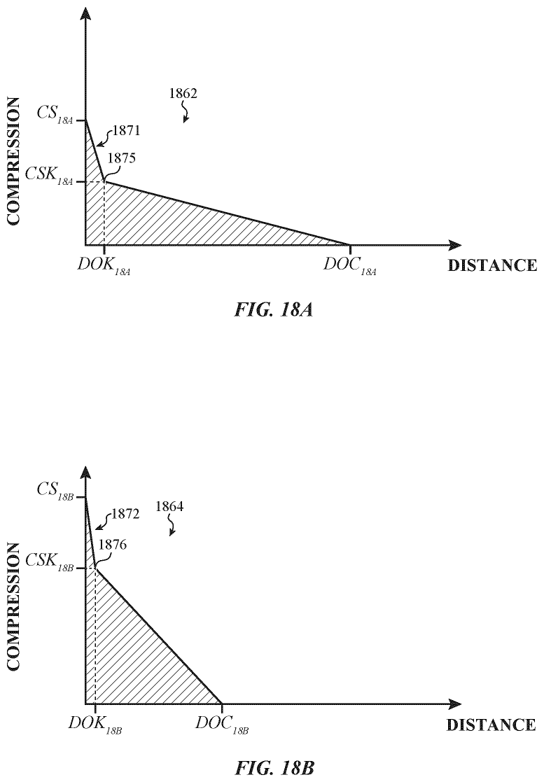

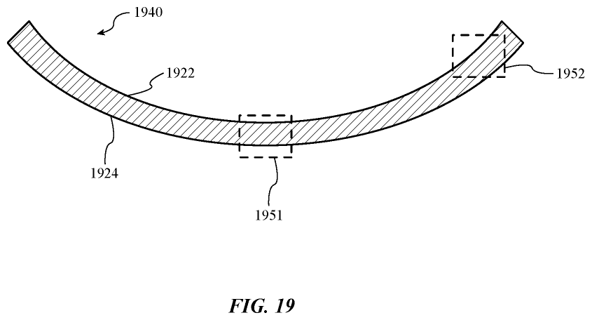

Alternately or additionally, the thermal treatment operation may occur prior to an ion exchange operation and may be used to modify a structural density (alternately, spatial density) within a portion of the cover to be strengthened. The modification of the structural density can affect the subsequent ion exchange within the portion of the cover to be strengthened. Examples of using a thermal treatment operation to modify the structural density within a portion of the cover member are described with respect to FIGS. 18A, 18B, and 19 and the additional description provided with respect to these figures is generally applicable herein.

The internal stress distribution within a given strengthened portion or zone of the cover member may be measured at a convenient location within the portion or zone (e.g., not in a highly curved region). The internal stress profiles may be determined using techniques and equipment known in the art, such as equipment that determines stresses using optical waveguide methods or photoelastic methods (e.g., using a scattered light polariscope). In some cases, the internal stress profiles may be measured using a destructive method. In some examples, the surface concentration of one or more ions introduced by ion exchange, such as an average concentration of the ion(s) over a distance of 1 micrometer from the surface or a maximum concentration of one or more ions, may be used to assess relative amounts of ion exchange and stress formation. Alternately or additionally, the concentration profiles of one or more ions and features of these concentration profiles, such as a depth or a maximum slope of a concentration profile, may be used to assess ion exchange and or stress formation. The description of stress and concentration profiles and measurement techniques provided herewith is generally applicable to the cover members having compressive stress, tensile stress, and internal stress distributions described herein.

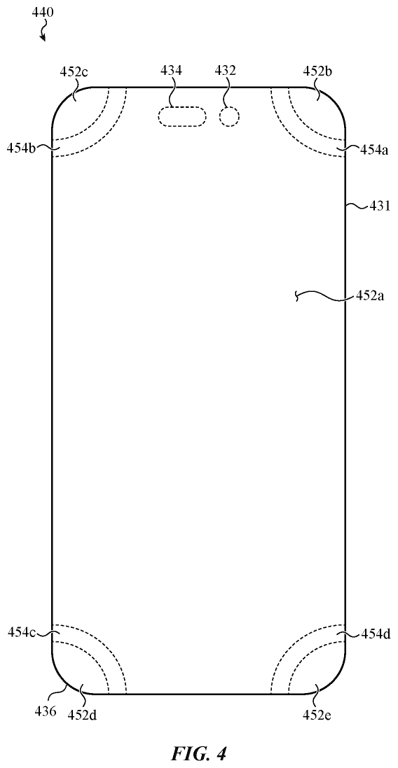

FIG. 4 shows another cover member for an electronic device that includes another example of a crack-resistant portion. The cover member 440 may be a front cover member of an electronic device that is positioned over a display, a camera, and a set of sensors. A camera region 432 and a sensor region 434 of the cover member 440 are shown with dashed lines in FIG. 4. The cover member 440 may be similar in composition, dimensions, and other features to the cover members 140 and 240 and that description is not repeated here. In some examples, the cover member 440 is included in a cover that may be similar to the front cover 120 and the electronic device may be similar to the device 100.

The cover member 440 includes multiple strengthened portions, a set of strengthened portions 452a, 452b, 452c, 452d, and 452e and a set of crack-resistant portions 454a, 454b, 454c, and 454d. The boundaries of the crack-resistant portions 454a, 454b, 454c, and 454d are shown with dashed lines. In some embodiments, each of the strengthened portions 452a through 452e has the same or a similar internal stress distribution. The set of strengthened portions may be viewed as forming a zone, which may be referred to herein as a primary zone. In some embodiments, each of the crack-resistant portions 454a through 454d has the same or a similar internal stress distribution. The set of crack-resistant portions may be viewed as forming a zone, which may be referred to herein as a crack-resistant zone.

In embodiments, each of the crack-resistant portions is strengthened differently from the strengthened portions 452a through 452e to allow the crack-resistant portions to deflect a propagating crack. Therefore, the internal stress distribution of each of the crack-resistant portions 454a through 454d differs from the internal stress distribution of the each of the strengthened portions 452a through 452e. The properties of the internal stress distribution of each of the crack-resistant portions 454a through 454d may be similar to those of the crack-resistant portion 254 and the properties of the internal stress distribution of each of the strengthened portions 452a through 452e may be similar to those of the strengthened portion 252a and those details are not repeated here. As shown in FIG. 4, each of the crack-resistant portions 454a through 454d is substantially continuous.

The configuration of the crack-resistant portions 454a through 454d shown in FIG. 4 may help contain a crack originating at corner region 436 of the cover member 440. Each of the crack resistant portions 454a through 454d partially surrounds a corner region 436 of the cover member 440. The crack-resistant portions 454a through 454d may therefore prevent this crack from reaching the camera region 432 and the sensor region 434 and may limit cracking of most of the region of the cover member 440 that is positioned over a display. The crack-resistant portions 454a through 454d may therefore help to preserve functionality of the display, the camera, and the set of sensors underlying the cover member 440.

The larger strengthened portion 452a of the cover member 440 is positioned over most of the display and also includes the camera region 432 and the sensor region 434. The smaller strengthened portions 452b, 452c, 452d, and 452e define corner regions 436 of the cover member 440. Each of the portions 452a through 452e define respective portions of the perimeter 431. Each of the crack-resistant portions 454a through 454d defines two regions of the perimeter 431 that are separated by a respective region of the perimeter defined by a respective portion of the portions 452b through 452e.

In the example of FIG. 4, the strengthened portions 452a through 452e and the crack-resistant portions 454a through 454d are shown as defining an entirety of the cover member 440. However, this example is not limiting and in other examples, the cover member may include an additional crack-resistant portion that extends around a perimeter of the cover member that is similar to the crack-resistant portion 1554 of FIG. 15 as previously described with respect to the cover member 240.

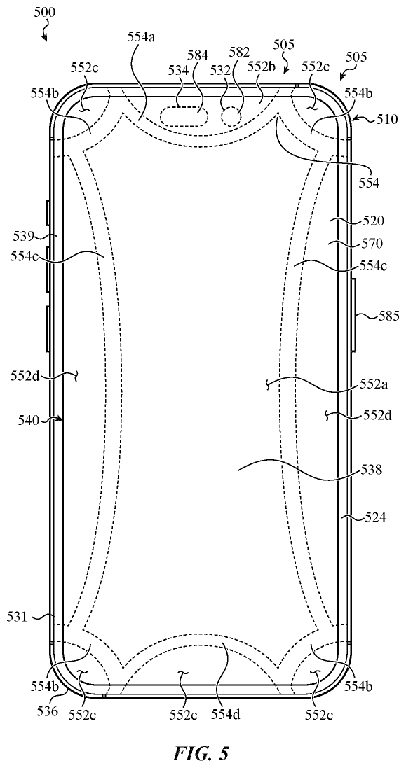

FIG. 5 shows another electronic device that has a cover member that includes multiple crack-resistant portions. The cover member 540 may be a front cover member of an electronic device that is positioned over a display, a camera, and a set of sensors. The electronic device 500 includes a display 570 as well as a front-facing camera 582 and a set of sensors 584. The set of sensors 584 may include a biometric sensor. As shown in FIG. 5, each of the cover 520 and the cover member 540 are positioned over the camera 582 and the set of sensors 584 as well as the display 570. In other examples, the cover member 540 may define one or more openings over a camera and/or a sensor. A camera region 532 and a sensor region 534 of the cover member 540 are shown with dashed lines in FIG. 5. The cover member 540 may be similar in composition and dimensions to the cover member 140 and that description is not repeated here.

The cover member 540 includes multiple strengthened portions. These strengthened portions include a set 554 of crack-resistant portions as well as the strengthened portions 552a, 552b, 552c, 552d, and 552e. In some embodiments, each of the strengthened portions 552a through 552e has the same or a similar internal stress distribution. The set of strengthened portions may be viewed as forming a zone, which may be referred to herein as a primary zone. Each of the strengthened portions 552b through 552e defines a respective portion of the perimeter 531.

The set 554 of crack-resistant portions may be viewed as forming a crack-resistant zone. As shown in FIG. 5, the set 554 of crack-resistant portions includes crack-resistant portions 554a, 554b, 554c, and 554d. The crack-resistant portions 554a through 554d are interconnected and the set 554 of crack-resistant portions defines other portions of the perimeter 531.

Each portion of the set 554 of crack-resistant portions may prevent a crack originating in the peripheral region 539 of the cover member 540 from reaching the central region 538. The set 554 of crack-resistant portions may therefore limit cracking over the portion of the display that is positioned below the central region 538. In some cases, one or more of the crack-resistant portions may prevent a crack from reaching the camera region 532 and the sensor region 534. The set 554 of interconnected crack-resistant portions may therefore help to preserve functionality of the display, the camera, and the set of sensors underlying the cover member 540. The number of crack-resistant portions shown in the example of FIG. 5 is exemplary rather than limiting and in other examples a cover member may have a greater number or a fewer number of crack-resistant portions and/or the crack-resistant portions of the cover member need not be interconnected. For example, a cover member may have a crack-resistant portion that partially surrounds a sensor region and one or more crack-resistant portions that partially surround a corner region of the cover member.

Each crack-resistant portion of the set 554 of crack-resistant portions partially surrounds a respective strengthened portion of strengthened portions 552a, 552b, 552c, 552d and 552e. For example, the set 554 of crack-resistant portions may partially surround one or more of the camera region 532, the sensor region 534, corner regions 536, or other portions of the peripheral region of the cover member 540. As shown in FIG. 5, the set 554 of crack-resistant portions is substantially continuous and also surrounds the central portion 538 of the cover member 540.

The internal stress distributions of the crack-resistant portions of the set 554 of crack-resistant portions may be similar to each other or may differ from one other. In some cases, it may be desirable to provide greater crack-resistance to one or more of the crack-resistant portions. For example, providing a greater amount of crack-resistance to a crack-resistant portion that partially surrounds a corner region 536 of the cover member (e.g., the crack-resistant portion 554b) may provide greater protection against a crack originating in the corner region 536. The properties of the internal stress distribution of the crack-resistant portions 554a, 554b, 554c, and 554d may be similar to those of the crack-resistant portion 254 and the properties of the internal stress distribution of the strengthened portions 552a, 552b, 552c, 552d, and 552e may be similar to those of the strengthened portion 252a and those details are not repeated here.

In some embodiments, it may be desirable to limit the volume of the crack-resistant portions within the cover member. For example, when the crack-resistant portions introduce higher tensile stress into the cover, it may be desirable to limit the volume of the crack-resistant portions in order to limit the amount of tensile stress created in the cover member In some embodiments, the volume percentage of the crack resistant portion(s) may be from 1% to 40%, from 1% to 30%, from 5% to 30%, or from 1% to 20%.

The cover 520 is coupled to the housing 510 and includes the cover member 540. The cover 520 of FIG. 5 also includes an interior coating 524 disposed on a peripheral portion of the cover member 540. The interior coating 524 may act as a mask to obscure components positioned within an interior of the enclosure 505. The electronic device 500 further defines an input member 585.

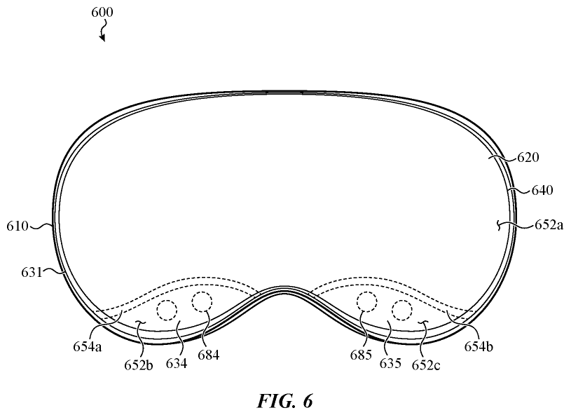

FIG. 6 shows an electronic device 600 that includes multiple crack-resistant portions. The electronic device 600 may be a headset computing device. The electronic device 600 includes a cover 620 and a cover member 640 of the cover 620 includes the crack-resistant portions. In some embodiments, the cover member 640 is contoured rather than having a shape that is completely flat. A contoured cover or cover member may alternately be referred to herein as having a three-dimensional shape The cover member 640 includes sensor regions 634 and 635 that are positioned over one or more sensors 684, 685 (shown with dashed lines in FIG. 6). The example of FIG. 6 is exemplary and is not intended to be limiting with respect to the number of sensors present in the electronic device and in other examples a greater or a lesser number of sensors may be present, and the number of sensor regions adjusted accordingly. The electronic device may further include a display. The cover member 640 may be similar in composition and dimensions to the cover member 140 and that description is not repeated here.

The cover member 640 includes multiple strengthened portions. These strengthened portions include a first strengthened portion 652a, a second strengthened portion 652b, and a third strengthened portion 652c, a first crack-resistant portion 654a and a second crack-resistant portion 654b. The boundaries of the first and the second crack-resistant portions are shown with dashed lines. The set of strengthened portions 652a, 652b, and 652c may be viewed as forming a zone, which may be referred to herein as a primary zone.

Each of the first and second crack resistant portions 654a and 654b is strengthened differently from the first, second, and third strengthened portions 652a, 652b, and 652c in order to achieve deflection of a propagation crack. Therefore, the internal stress distribution of each of the first and the second crack-resistant portions 654a and 654b differs from the internal stress distribution of the first through third strengthened portions 652a through 652c. The properties of the internal stress distribution of the crack-resistant portions 654a and 654b may be similar to those of the crack-resistant portion 254 and the properties of the internal stress distribution of the strengthened portions 652a through 652c may be similar to those of the strengthened portion 252a and those details are not repeated here.

The crack-resistant portion 654a partially surrounds the sensor region 634 and extends to the perimeter 631 of the cover member. The crack-resistant portion 654b partially surrounds the sensor region 635 and extends to the perimeter 631. Each of the crack-resistant portions 654a and 654b is substantially continuous.

The cover member includes strengthened portions 652a, 652b, and 652c. The strengthened portion 652b includes the sensor area 634 and the portion 652c of the primary strengthened portion 652b includes the sensor area 635. Each of the strengthened portions 652a, 652b, and 652c defines a respective portion of the perimeter 631 of the cover member 640. Each of the crack-resistant portions 654a and 654b also defines a respective portion of the perimeter 631.

The configuration of the crack-resistant portions 654a and 654b shown in FIG. 6 may divert a crack approaching a sensor region, such as the sensor regions 634 and 635, from the strengthened portion 652a. The crack-resistant portions 654a and 654b can therefore help to preserve functionality of one or more sensors underlying the cover member 640.

The cover member 640 is included in a cover 620, that may be coupled to a housing 610. In some embodiments, the cover 620 may have a laminate structure, with the ion-exchangeable cover member 640 defining one layer of the laminate. In some embodiments, the cover 620 may include an interior coating. The electronic device 600 may further include one or more additional components such as input members, displays, sensors, and the like.

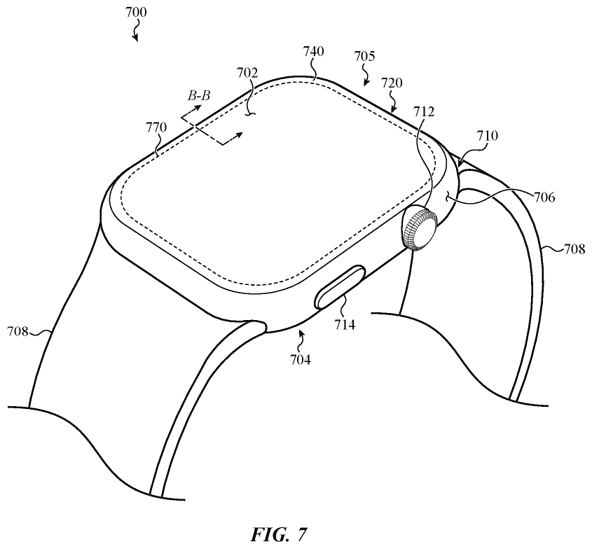

FIG. 7 shows a view of another example electronic device. The device of FIG. 7 may be a wearable electronic device, such as a watch (e.g., an electronic watch, such as a smartwatch) or another wrist-worn device.

The electronic device 700 includes an enclosure 705. The enclosure includes a housing 710 and a front cover 720 that defines at least a portion of a front surface 702 of the electronic device. The front cover 720 is positioned over a display assembly 770. The enclosure may also include a rear cover that may be positioned over a sensing panel.

The cover member 740 may include a crack-resistant portion. The crack-resistant portion can help preserve functionality of the electronic device by deflecting a crack away from a crack-sensitive portion of the cover member. Examples of such crack-resistant portions are shown at least in FIGS. 9 and 10.

In the example of FIG. 7, the cover member 740 is contoured. In some cases, the cover member is shaped so that a central region of the cover member protrudes with respect to a peripheral region. Alternately, the central region of the cover member may be referred to as being offset (e.g., in a vertical direction) with respect to the peripheral region. The partial cross-sectional view of FIG. 8 shows an example of a contoured cover. In some cases, the thickness of the cover member 740 can vary, an example of which is also shown in FIG. 8. The cover member 740 may include or be formed of any of the ion-exchangeable materials previously described with respect to the cover member 140.

The enclosure 705 defines an internal cavity into which one or more device components is placed. The electronic device 700 includes a display assembly 770 and may also include a rear sensing panel. The electronic device 700 includes an input device 712, which may be a dial having an outer surface configured to receive a rotary input. The electronic device 700 also includes an input device 714, which may be a button configured to receive a touch or press input. A band 708 is attached to the housing 710 and is configured to secure the electronic device to a user.

The housing 710 at least partially defines a side surface 706 of the electronic device. In some examples, the housing 710 may define all or part of the rear surface 704 of the electronic device. In some cases, the housing 710 is formed of a metal material, such as an iron-based alloy (e.g., steel), a titanium-based alloy, an aluminum-based alloy, a magnesium-based alloy, or the like. In other cases, the housing 710 may be formed from a glass, a glass ceramic, or a ceramic material.

FIG. 8 shows a partial cross-section view of an example contoured cover member. The cover member 840 may be an example of the cover member 740 of the device 700 and the view may be along line B-B. The cover member 840 includes a transition region 837 that provides a transition between a central region 838 and a peripheral region 839 of the cover member. Both the exterior surface 822 and the interior surface 824 of the cover member 840 are curved in the transition region 837, but the curvature along the interior surface 824 is more pronounced. The exterior surface 822 defines a convex curve and the interior surface 824 defines a concave curve in the transition region 837.

The thickness of the cover member 840 varies, particularly in the transition region 837, which defines a locally thin location 847 of the cover member 840. A transition region such as the transition region 837 may alternately be referred to as an elbow region herein. The example of the thickness variation in FIG. 8 has been provided for purposes of illustration and in other examples the variation in cover member thickness may be less than shown in FIG. 8.

FIG. 8 schematically illustrates regions of compressive and tensile stress in the transition region 837 of the cover member 840. The cover member 840 includes a compressive stress region 863 extending from the exterior surface 822 and a compressive stress region 864 extending from the interior surface 824 of the cover member 840. The cover member 840 also includes a tensile stress region 883 positioned between the compressive stress regions 863 and 864. In the example of FIG. 8, the locally thin location 847 in the transition region 837 may produce an internal stress distribution 857 that has higher level of maximum or central tension that at other locations in the transition region.

In some embodiments, the cover member 840 may be strengthened to include one or more crack-resistant portions configured to divert a crack from propagating in the transition region 837. The crack may originate from the transition region 837 (e.g., due to impact) or may originate from another portion of the cover member 840. For example, a crack-resistant portion of the cover member 840 may be configured to direct a crack away from one or more locations in the transition region 837 that may be more susceptible to cracking, including locations where the internal stress distribution has a higher level of maximum or central tension that other locations in the cover member. Therefore, strengthening the cover to include crack resistant portions can help preserve integrity of the cover member and functionality of the electronic device.

FIG. 9 shows a front view of a contoured cover member that includes multiple crack-resistant zones. The cover member 940 may be included in a cover for a wearable electronic device, such as a smartwatch. The electronic device and the cover may have similar properties to the electronic device 700 and the cover 720 of FIG. 7.

The cover member 940 includes a central region 938, a peripheral region 939, and a transition region 937. As shown in the example of FIG. 9, the peripheral region 939 extends to an edge 931 of the cover member and defines corner regions 936. The transition region 937 may define curved exterior and exterior surfaces of the cover member 940, an example of which is shown in the partial cross-sectional view of FIG. 8. The example of FIG. 9 is not intended to be limiting and in other examples the edge 931 of the cover member 940 may define a generally circular rather than a generally rectangular outline with four corner regions 936.

The cover member 940 includes a set of crack-resistant zones 954 that are produced by strengthening the cover member. Each crack-resistant zone 954 of the set of crack-resistant zones is spaced apart from an adjacent crack-resistant zone of the set of crack resistant zones 954. In the example of FIG. 9, the cover member 940 includes a set of four crack-resistant zones 954. The boundaries of the crack-resistant zones 954 are shown with dashed lines.

In the example of FIG. 9, each of the crack-resistant zones 954 extends from the edge 931 of the cover member and over a portion of the transition region 937. Therefore, each of the crack-resistant zones may include a strengthened portion of the peripheral region and a strengthened portion of the transition region. The crack-resistant zones may further extend into the central region 938, so that the crack resistant zone further includes a strengthened portion of the central region. The crack-resistant zones 954 may extend from the corners 936. The crack-resistant zones may have a second internal stress distribution. In the example of FIG. 9, each of the crack-resistant zones 954 extends from a respective corner region 936 of the cover member. As shown in FIG. 9, each of the crack-resistant zones 954 has an elongated shape, with a length that exceeds a width of the crack-resistant zone 954. The example of FIG. 9 is not intended to be limiting and in other examples the crack-resistant zones may define a C-shape or any other suitable shape and/or a different number of crack-resistant zones may be present. As previously discussed, the term crack-resistant zone may be used for convenience to refer to a crack-resistant portion that extends across multiple strengthened portions of the cover member.

The cover member 940 further defines a first strengthened portion 952 and a third strengthened portion 956. The central region 938 of the cover member 940 includes the first strengthened portion 952 and the first strengthened portion 952 has a first internal stress distribution. The transition region 937 of the cover member 940 includes the third strengthened portion 956 and the third strengthened portion 956 has a third internal stress distribution. The crack resistant zones 954 (which can be viewed as defining a second strengthened portion) have a second internal stress distribution.

In some embodiments, the second internal stress distribution of the crack-resistant zones 954 may have a greater compressive stress profile integral than the first internal stress distribution of the strengthened portion 952. In some cases, a crack-resistant zone 954 may therefore help divert a crack propagating in the transition region 937 into the first strengthened portion of the central region 938 that has the first internal stress distribution. Examples of compressive stress profiles having different values of compressive stress profile integrals were previously shown and discussed with respect to FIGS. 3A and 3B and that discussion is not repeated here. For similar reasons as previously discussed with respect to FIGS. 3A and 3B, a greater compressive stress profile integral in the second internal stress distribution of the crack-resistant zones 954 may help retard propagation of a crack through the compressive stress regions of the crack-resistant zones 954. In some cases, a greater knee compressive stress (CSK) at the transition of a crack-resistant zone 954 as compared to the knee compressive stress at the transition of the first strengthened zone 952 may be related to greater retardation of crack propagation. The internal stress distribution within a given strengthened portion or zone may be measured at a convenient location within the strengthened portion or zone, as previously described.

When the thickness of the cover member 940 varies, this thickness variation can produce additional variation of the distribution of internal stress within the cover member. In the case that the transition region 937 defines a locally thin location of the cover member 940, the third internal stress distribution in the transition region 937 may be different from each of the first and the second internal stress distributions. In some examples, the third internal stress distribution may have a third compressive stress profile that is similar to the first compressive stress profile of the first internal stress distribution. However, the maximum or central tension of the third internal stress distribution may be greater than that of the first internal stress distribution due to the reduced thickness in the transition region 937 for similar reasons as previously discussed with respect to the example of FIG. 8.

FIG. 10 shows a front view of another contoured cover member that includes multiple crack-resistant zones. The cover member 1040 may be included in a cover for a wearable electronic device, such as a smartwatch. The electronic device and the cover may have similar properties to the electronic device 700 and the cover 720 of FIG. 7.

The cover member 1040 includes a central region 1038, a peripheral region 1039, and a transition region 1037. As shown in the example of FIG. 10, the peripheral region 1039 extends to an edge 1031 of the cover member and defines corner regions 1036. The transition region 1037 may define curved exterior and exterior surfaces of the cover member 1040, an example of which is shown in the partial cross-sectional view of FIG. 8. The example of FIG. 10 is not intended to be limiting and in other examples the edge 1031 of the cover member 1040 may define a generally circular rather than a generally rectangular outline.

The cover member 1040 includes a set of crack-resistant zones 1054 that are produced by strengthening the cover member. Each crack-resistant zone 1054 of the set of crack-resistant zones is spaced apart from an adjacent crack-resistant zone. In the example of FIG. 10, the cover member 1040 includes a set of four crack-resistant zones 1054. The boundaries of the crack-resistant zones 1054 are shown with dashed lines.

In the example of FIG. 10, each of the crack-resistant zones 1054 extends from the edge 1031 of the cover member and over a portion of the transition region 1037. Therefore, each of the crack-resistant zones may include a strengthened portion of the peripheral region and a strengthened portion of the transition region. The crack-resistant zones may further extend into the central region 1038, so that the crack resistant zone further includes a strengthened portion of the central region. The crack-resistant zones may have a second internal stress distribution. In the example of FIG. 10, each of the crack-resistant zones 1054 extends from a respective corner region 1036 of the cover member. In contrast to the example of FIG. 9, each of the crack-resistant zones 1054 defines a wedge shape that is broader in the peripheral region 1039 than in the central region 1038. The crack-resistant zones 1054 may include the corners 1036.

The cover member 1040 further defines a first strengthened portion 1052 and a third strengthened portion 1056. The central region 1038 of the cover member 1040 includes the first strengthened portion 1052 and the first strengthened portion 1052 has a first internal stress distribution. The transition region 1037 of the cover member 1040 defines the third strengthened portion 1056 and the third strengthened portion 1056 has a third internal stress distribution. The crack resistant zones 1054 (which can be viewed as defining a second strengthened portion) have a second internal stress distribution.

In some embodiments, the second internal stress distribution of the crack-resistant zones 1054 may have a lesser tensile stress profile integral than the first internal stress distribution of the strengthened portion 1052. The lesser tensile stress profile integral in the crack-resistant zones may reduce the driving force for crack propagation and therefore a crack-resistant zone 1054 may help divert a crack propagating in the transition region 1037 into the first strengthened portion 1052 of the central region 1038 that has the first internal stress distribution. In contrast to the example of FIG. 9, the second internal stress distribution in the crack-resistant zone 1054 may have a lower compressive stress profile integral than the first internal stress distribution, as shown in the examples of FIGS. 11A and 11B. The second internal stress distribution may be configured so that the decrease in the driving force for crack propagation provided by the tensile stress region outweighs any decrease in crack retarding effect provided by the compressive stress regions. The internal stress distribution within a given strengthened portion or zone may be measured at a convenient location within the strengthened portion or zone.

FIG. 11A shows an example of a compressive stress profile and part of a tensile stress profile in a strengthened portion of a cover member. The partial tensile stress profile 1166 may be an example of part of the tensile stress profile in the first strengthened portion 1052 of FIG. 10. The partial tensile stress profile 1166 has a maximum tension value. When the internal stress distribution is symmetric, this maximum tension value may be a central tension value CT_{11A}. The compressive stress profile 1162 may be an example of the compressive stress profile in the first strengthened portion 1052 of FIG. 10. The compressive stress profile 1162 has a surface compressive stress CS_{11A}, a depth of compression DOC_{11A}, and a slope transition 1175. The slope transition 1175 is associated with a compressive stress CSK_{11A} and a depth DOK_{11A}. The compressive stress profile 1162 also has a surface portion and a core portion as previously described with respect to FIGS. 3A and 3B.

FIG. 11B shows another example of a compressive stress profile and part of a tensile stress profile in a zone of the cover member that can retard propagation of a crack. This zone may be alternately referred to herein as a crack-resistant zone. The partial tensile stress profile 1168 may be an example of part of the tensile stress profile in the crack-resistant zone 1054 of FIG. 10. The partial tensile stress profile 1168 has a maximum tension value. When the internal stress distribution is symmetric, this maximum tension value may be a central tension value CT_{11B}. The compressive stress profile 1164 may be an example of the compressive stress profile in the crack-resistant zone 1054 of FIG. 10. The compressive stress profile 1164 has a surface compressive stress CS_{11B}, a depth of compression DOC_{11B}, and a slope transition 1176. The slope transition 1176 is associated with a compressive stress CSK_{11B} and a depth DOK_{11B}. The compressive stress profile 1164 also has a surface portion and a core portion as previously described with respect to FIGS. 3A and 3B.

As shown in FIGS. 11A and 11B, the tensile stress profile 1168 of the crack-resistant zone is different from the tensile stress profile 1166 of the first strengthened portion. Several of these differences can contribute to the greater crack-resistance provided by the tensile stress profile 1168 of the crack-resistant zone as compared to the tensile stress profile 1166 of the first strengthened portion. As an example, the lesser tensile stress profile integral provided by the tensile stress profile 1168 of the crack-resistant zone as compared to the tensile stress profile integral provided by the tensile stress profile 1166 of the first strengthened portion may help retard propagation of a crack through the tensile stress region of the crack-resistant zone of the cover member. The central tensile stress CT_{11B} of the crack-resistant zone is also lower than the central tensile stress CT_{11A} of the first strengthened portion.

The compressive stress profile 1164 of the crack-resistant zone is also different from the compressive stress profile 1162 of the first strengthened portion. As shown in FIGS. 11A and 11B, the compressive stress profile integral provided by the compressive stress profile 1164 of the crack-resistant zone is less than the compressive stress profile integral of the compressive stress profile 1162 of the first strengthened portion. The second internal stress distribution in the crack-resistant zone may be configured so that the decrease in the driving force for crack propagation provided by the tensile stress region outweighs any decrease in crack retarding effect provided by the compressive stress regions. The compressive stress profile 1164 of the crack-resistant zone has a lesser surface compressive stress CS_{11B} and a knee compressive stress CSK_{11B} than the surface compressive stress CS_{11A} and the knee compressive stress CSK_{11A} of the compressive stress profile 1162 of the first strengthened portion. The depth of compression DOC_{11B} of the crack-resistant zone need not be substantially different than the depth of compression DOC_{11A} of the first strengthened portion, as schematically illustrated in FIGS. 11A and 11B. The compressive stress and tensile stress profiles shown in FIGS. 11A and 11B are exemplary rather than limiting. and in other examples a different compressive stress profile and/or tensile stress profile may be used to provide crack resistance. As examples, the depth of compression of a crack-resistant zone may be less than the depth of compression of the other strengthened portion.

In some embodiments, the internal stress distribution of FIG. 11B may be obtained by forming an internal stress distribution similar to that of FIG. 11A and then performing an additional ion exchange operation by similar methods as previously described. The additional ion exchange may be an operation in which potassium ions present in the ion-exchanged cover glass are replaced with sodium ions from an ion-exchange medium. In this example, the replacement of potassium ions with sodium ions can lower the surface compressive stress and the knee compressive stress, but also increase the knee depth. This example is not intended to be limiting and in additional examples the internal stress distribution of FIG. 11B may be obtained by another method described herein.

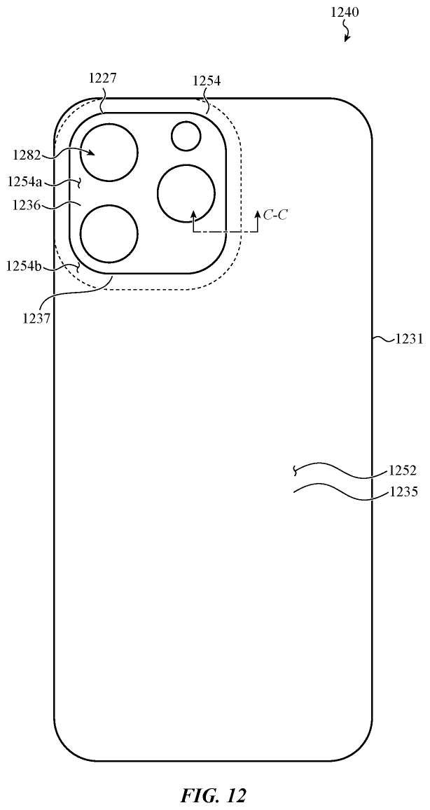

FIG. 12 shows another example of a cover member for an electronic device. The cover member 1240 includes a zone 1254 that is strengthened differently from the strengthened portion 1252. The cover member 1240 defines a protruding feature 1227 that is located within the zone 1254. In some examples, the protruding feature 1227 may define a camera turret. The cover member 1240 may be an example of the cover member 141 of FIG. 1B. The cover member 1240 may be similar in composition and dimensions to the cover member 141 and that description is not repeated here.

The cover member 1240 defines a first region 1235 and a second region 1236 that is offset with respect to the first region 1235. The cover member 1240 further defines a third region 1237 that extends between the first region 1235 and the second region 1236. The second region 1236 and the third region 1237 together define the protruding feature 1227. The region 1236 may alternately be referred to as a sensor region. As shown in the example of FIG. 12, the second region 1236 defines a plurality of openings 1282. When the cover member 1240 is included in an electronic device, at least one sensor of the electronic device may extend into an opening of the plurality of openings. The first region 1235 may alternately be referred to as a base region and the second region 1236 may alternately be referred to as a raised region or a sensor region herein. FIG. 13 shows an example of a partial cross-sectional view of these regions of a cover member. The example of FIG. 12 is not limiting and in other examples the cover member 1240 may define a greater or a lesser number of openings.

The cover member 1240 includes multiple strengthened portions, a first strengthened portion 1252, a second strengthened portion 1254a, and a third strengthened portion 1254b. The first region 1235 comprises the first strengthened portion 1252, the second region 1236 comprises the second strengthened portion 1254a, and the third region 1237 comprises the third strengthened portion 1254b. The strengthened zone 1254 includes the second strengthened portion 1254a and the third strengthened portion 1254b. A boundary of the third strengthened portion 1254b is shown with dashed lines and may represent a boundary between the first strengthened portion 1252 and the third strengthened portion 1254b.

The strengthened zone 1254 may be strengthened differently from the first strengthened portion 1252 in order to provide improved resistance to formation of a crack that extends into the zone 1254 of the cover member. Therefore, the strengthened zone 1254 may alternately be referred to herein as a crack-resistant zone. In some embodiments, each of the first strengthened portion 1252 and the strengthened zone 1254 provides crack-resistance but the difference in strengthening reflect the strengthening most beneficial to the region(s) of the cover member in which the strengthened portion or zone is located. As an example, the strengthened zone 1254 may provide greater resistance to a crack that extends through a compressive stress layer of the cover member in the second region 1236 and the third region 1237. In some cases, an additional ion-exchange operation may be used to form the second and third strengthened portions of the strengthened zone 1254 in a similar fashion as previously discussed. Therefore, each of a second internal stress distribution of the second strengthened portion 1254a and a third internal stress distribution of the third strengthened portion 1254b of the strengthened zone 1254 may be different from the first internal stress distribution of the first strengthened portion 1252.

Each of the first, the second, and the third strengthened portions of the cover member include a respective compressive stress region extending from an exterior surface of the cover member. In some embodiments, each of the second compressive stress region of the second strengthened portion and the third compressive region of the third strengthened portion is different from the first compressive stress region of the first strengthened portion.

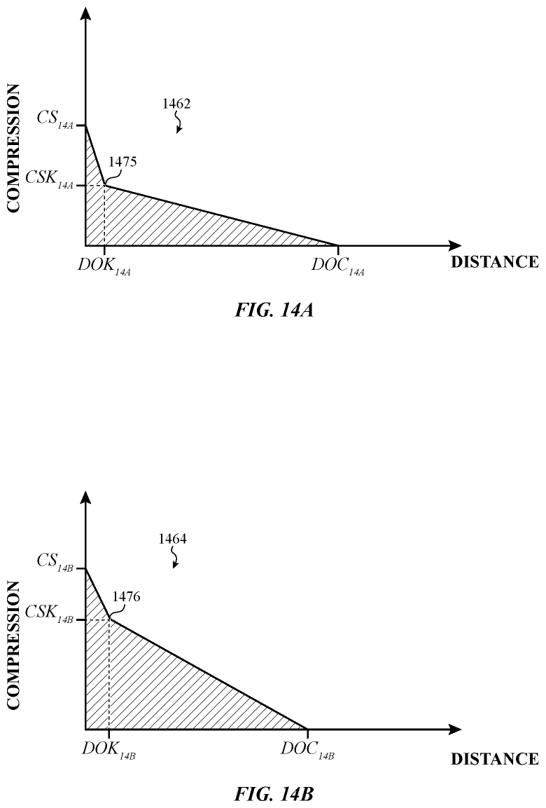

In some cases, at least one compressive stress parameter of the second compressive stress region of the second strengthened portion and/or the third compressive region of the third strengthened portion has a value that is greater than the value of the compressive stress parameter for the first compressive stress region of the first strengthened portion. As examples, the compressive stress parameter may be a profile integral of the compressive stress profile, a surface compressive stress value, a maximum compressive stress value, a compressive stress value at a specified depth from a surface of the cover member, a knee compressive stress value, an ion concentration, a depth of compression, a knee depth, or the like. The compressive stress parameter of the second strengthened portion may be referred to as a second compressive stress parameter and the compressive stress parameter of the first strengthened portion may be referred to as a first compressive stress parameter. Increasing the value of the compressive stress parameter in the second compressive stress region of the second strengthened portion 1254a can help protect the cover member 1240 from crack formation due to an impact or another source of mechanical stress applied to the protruding feature 1227. Increasing a value of the compressive stress parameter in the third compressive stress region of the third strengthened portion 1254b can help to compensate for geometrical features near the base of the protruding feature that may tend to limit development of compressive stress. Examples of an internal stress distribution of a crack-resistant zone as compared to the first strengthened portion 1252 are shown in the examples of FIGS. 14A and 14B. All or part of the internal stress distribution in the cover member may be measured at any convenient location within the strengthened portion or zone.

As previously discussed, some internal stress measurement techniques may be less compatible with curved surfaces, side surfaces, and/or relatively small feature sizes. In cases where the geometry of the cover member is less compatible with standard internal stress measurement techniques, relative amounts of compressive stress may be assessed by comparing the surface concentration of one or more ions introduced by ion exchange, such as an average concentration of the ion(s) over a distance of 1 micrometer from the surface. In the example of FIG. 12, the first compressive stress region may in some embodiments have a first average surface concentration of sodium ions and a first average surface concentration of potassium ions and each of the second compressive stress region and the third compressive stress region may have a second average surface concentration of sodium ions that is greater than the first average surface concentration of sodium ions and a second average surface concentration of potassium ions that is less than the first average surface concentration of potassium ions. In some embodiments, the third compressive stress region may have a third average surface concentration of sodium ions that is greater than the first average surface concentration of sodium ions and different than a second average concentration of sodium ions of the second compressive stress region and a third average surface concentration of potassium ions that is greater than the first average surface concentration of potassium ions and that is different from the second average surface concentration of potassium ions of the second compressive stress region.

These surface concentrations may be obtained, for example, by exposing the entire cover member to an ion-exchange medium in a first ion-exchange operation that exchanges lithium ions in the cover member with sodium ions and potassium ions from the ion-exchange medium, masking the region 1235, and then exposing the regions 1236 and 1237 to an ion-exchange medium in a second ion-exchange operation. In some examples, the second ion-exchange operation may exchange potassium ions in the cover member with sodium ions to obtain the ion surface concentrations as described above. Alternately or additionally, the second ion-exchange operation may introduce additional potassium ions into the cover member.

The cover member 1240 further defines a perimeter 1231. In some examples, the first region 1235 and the first strengthened portion 1252 each extend to the perimeter 1231. In other examples, the cover member 1240 includes a peripheral region that defines the perimeter 1231 and that is strengthened differently than the first region 1235. As examples, the peripheral region may be strengthened similarly to the second strengthened portion 1254a and/or the third strengthened portion 1254b or may be strengthened similarly to the peripheral region 1539 of FIG. 15.

FIG. 13 shows an example partial cross-sectional view of the cover member of FIG. 12. The cover member 1340 defines an exterior surface 1322 and an interior surface 1324. When the cover member 1340 is included in an electronic device, the interior surface 1324 faces an internal cavity of the electronic device. The example of FIG. 13 may be a view along line C-C in FIG. 12. The cover member 1340 may be formed from a single piece of material.

The cover member 1340 defines a first region 1335 and a second region 1336. The cover member 1340 further defines a third region 1337 that extends between the first region 1335 and the second region 1336. Each of the first region 1335, the second region 1336, and the third region 1337 defines a respective portion of the exterior surface 1322 of the cover member 1340. The second portion of the exterior surface 1322 defined by the second region 1336 is offset with respect to the first portion of the exterior surface defined by the first region 1335. As shown in the example of FIG. 13, the second region 1336 has a thickness t₂ that is greater than the thickness t₁ of the first region 1335 and the second region 1336 and the third region 1337 together define the protruding feature 1327.

The cover member 1340 has been strengthened by forming compressive stress layers along the exterior surface 1322 and the interior surface 1324. The compressive stress layer 1361 along the exterior surface 1322 includes a first compressive stress region 1365 in the first region 1335 of the cover member, a second compressive stress region 1366 in the second region 1336 and a third compressive stress region 1367 in the third region 1337 of the cover member. FIGS. 14A and 14B show examples of compressive stress profiles in the first compressive stress region 1365 and the second compressive stress region 1366. The compressive stress profile in the third compressive stress region 1367 may be more difficult to measure using conventional techniques due to the curvature near the base of the protruding feature, but analysis of the composition in the third compressive stress region may be used to obtain information about the ion exchange in this region.

The compressive stress layer 1363 along the interior surface 1324 of the cover member 1340 also includes respective compressive stress regions along the first, second, and third regions of the cover member. In examples where the exterior and interior surfaces of the cover member are strengthened in a similar fashion, the first and second regions of compressive stress layer formed along the interior surface are similar to the first and the second regions of the compressive stress layer formed along the exterior surface. The third region of the compressive stress layer formed along the interior surface may be different than the third region of the compressive stress layer formed along the exterior surface due to the difference in shape of the external surface and the internal surface in the third region of the cover member. The boundaries of the compressive stress layers 1361 and 1363 are shown with dashed lines. A tensile stress region 1383 is positioned between the compressive stress layers 1361 and 1363.

FIGS. 14A and 14B show examples of compressive stress profiles in two different strengthened portions of a cover member. The compressive stress profile 1462 of FIG. 14A may be an example of the compressive stress profile in the first strengthened portion 1252 of FIG. 12 and the compressive stress profile 1464 may be an example of the compressive stress profile in the strengthened zone 1254 that includes the second strengthened portion 1254a and the third strengthened portion 1254b of FIG. 12.

FIG. 14A shows an example of a compressive stress profile in a first strengthened portion. The compressive stress profile 1462 may be an example of the compressive stress profile in the first strengthened portion 1252 of FIG. 12 and/or the first compressive stress region 1365. The compressive stress profile 1462 has a surface compressive stress CS_{14A}, a depth of compression DOC_{14A}, and a slope transition 1475. The slope transition 1475 is associated with a compressive stress CSK_{14A} and a depth DOK_{14A}. The compressive stress profile 1462 also has a surface portion and a core portion as previously described with respect to FIGS. 3A and 3B.

FIG. 14B shows an example of a compressive stress profile in another strengthened portion of the cover member. The other strengthened portion may be located within a crack-resistant zone. The compressive stress profile 1464 may be an example of the compressive stress profile in the crack-resistant zone 1254 of FIG. 12, such as the second strengthened portion 1254a and/or the second compressive stress region 1366. The compressive stress profile 1464 has a surface compressive stress CS_{14B}, a depth of compression DOC_{14B}, and a slope transition 1476. The slope transition 1476 is associated with a compressive stress CSK_{14B} and a depth DOK_{14B}. The compressive stress profile 1464 also has a surface portion and a core portion as previously described with respect to FIGS. 3A and 3B.

As shown in FIGS. 14A and 14B, the compressive stress profile 1464 of the crack-resistant zone is different from the compressive stress profile 1462 of the first strengthened portion. Several of these differences can contribute to the greater crack-resistance provided by the compressive stress profile 1464 as compared to the compressive stress profile 1462. As an example, the greater compressive stress profile integral provided by the compressive stress profile 1464 of the crack-resistant zone as compared to the compressive stress profile integral of the compressive stress profile 1462 of the first strengthened portion may help limit formation of a crack that extends through the compressive stress layer along the exterior surface of the cover member. As shown in FIGS. 14A and 14B, the compressive stress profile 1464 of the crack-resistant zone has a surface compressive stress CS_{14B} that is greater than the surface compressive stress CS_{14A} of the compressive stress profile 1462 of the first strengthened portion, which can contribute to a greater compressive stress profile integral of the compressive stress profile 1464. The compressive stress profile 1464 of the crack-resistant zone has a greater compressive stress CSK_{14B} at the transition 1476 of the crack-resistant zone as compared to the CSK_{14A} at the transition 1475 of the first strengthened portion. In the example of FIGS. 14A and 14B, the depth DOK_{14B} at the transition 1476 of the crack-resistant zone is greater than or equal to the depth DOK_{14A} at the transition 1475 of the first strengthened portion. However, the depth of compression DOC_{14B} of the crack-resistant zone is not substantially greater than the depth of compression DOC_{14A} of the first strengthened portion in the example of FIGS. 14A and 14B. The compressive stress profiles shown in FIGS. 14A and 14B are exemplary rather than limiting. and in other examples a different compressive stress profile may be used to provide crack resistance. As examples, the depth of compression of a crack-resistant zone may be greater than the depth of compression of a first strengthened portion and/or the relative surface compressive stresses may be different than shown in FIGS. 14A and 14B.

As previously discussed with respect to FIG. 13, the cover member may have compressive stress layers extending from each of the exterior and the interior surfaces of the cover member, with a tensile stress region positioned between these compressive stress layers. Typically, the internal stress profile includes both compressive and tensile stress profiles. In some embodiments, the compressive stress profiles 1462 and 1464 represent compressive stress profiles of the compressive stress layer extending from the exterior surface of the cover member. In some examples, the internal stress profile is symmetric.

In some embodiments, the compressive stress profile of FIG. 14B may be obtained by forming a compressive stress profile similar to that of FIG. 14A and then performing an additional ion exchange operation. The compressive stress profile of FIG. 14A may be obtained by one or more ion exchange operations similar to those previously described. During the additional ion-exchange operation, a portion of the cover member may be selectively exposed to an additional ion-exchange medium and/or a source of energy by methods similar to those previously described. For the example of FIG. 12, the second region 1236 and the third region 1237 may be selectively exposed to the additional ion-exchange medium and/or a source of energy. In some embodiments, a side surface of the cover member 1240 may also be selectively exposed to the additional ion-exchange medium and/or a source of energy.

As examples, the additional ion exchange operation may be an operation in which potassium ions present in the ion-exchanged cover glass are replaced with sodium ions from an ion-exchange medium and/or in which additional potassium ions are introduced into the cover member. The composition of the cover member within the compressive stress region may be modified accordingly. The increase in the concentration of the ions being introduced at a given depth from the surface may be at least 25%, at least 40%, or at least 50%. The additional ion exchange operation can increase the knee compressive stress and/or the surface compressive stress. In some embodiments, the additional ion exchange operation can increase the depth of the knee and/or the depth of compression. In some cases, the additional exchange may modify the internal stress profile of the other portions of the cover member (e.g., by additional diffusion of ions within the cover member), but to a lesser extent.

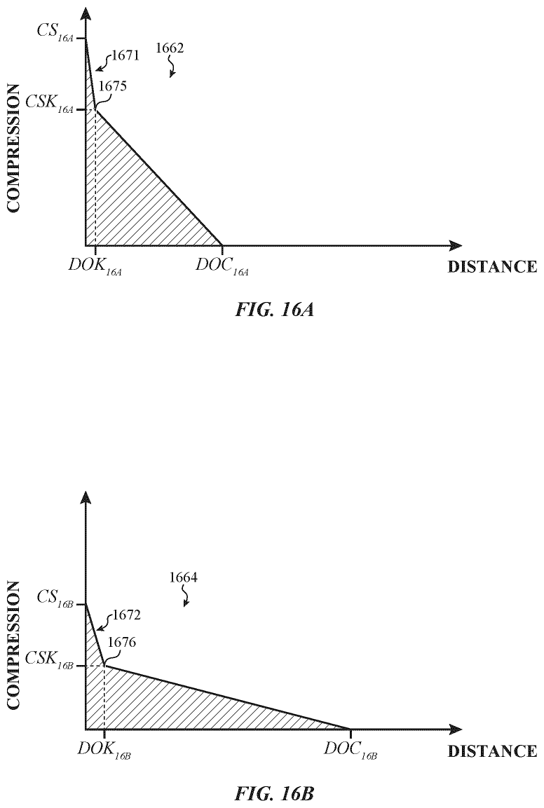

FIG. 15 shows another cover member for an electronic device that includes a peripheral region 1539 that is strengthened differently from at least one other region of the cover member. In some examples, a strengthened portion of the peripheral region may have an increased depth of compression as compared to another strengthened portion of the cover member 1540, as discussed below with respect to the examples of FIGS. 16A-16B and 17A-17B. The increased depth of compression within the peripheral region 1539 may improve the impact resistance of the peripheral region 1539, as discussed in more detail below.

The cover member 1540 may be a front cover member of an electronic device that is positioned over a display and a set of sensors. The cover member 1540 may be similar in composition and dimensions to the cover member 140 or the cover member 141 and that description is not repeated here. The cover member 1540 may be included in a front cover or a rear cover of an electronic device, which may any of the electronic devices described herein.

The cover member 1540 includes a first region 1538, a second region 1534, and a third region 1539. At least a portion of the first region 1538 may be positioned over the display. The second region 1534 may be positioned over a set of sensors and/or a camera and may alternately be referred to as a sensor region herein. The third region 1539 may define a side surface 1506 that extends between the exterior and the interior surfaces and which in turn defines a perimeter 1531 of the cover member. The third region 1539 may alternately be referred to as a peripheral region herein. In some examples, the third region 1539 of the cover member defines a curved side surface or edge of the cover member 1540. The second region 1534 may alternately be referred to as a sensor region. In the example of FIG. 15, the third region 1539 surrounds the first region 1538 and the second region 1534 of the cover member 1540.

The cover member 1540 includes two strengthened portions, a first strengthened portion 1552 and a second strengthened portion 1554. The first region 1538 and the second region 1534 of the cover member comprise the first strengthened portion 1552 (alternately, the first portion 1552). The third region 1539 of the cover member 1540 comprises the second strengthened portion 1554 (alternately, the second portion 1554). When the first strengthened portion 1552 covers a larger area than the second strengthened portion 1554, the first strengthened portion 1552 may alternately be referred to as a primary strengthened portion.

The second strengthened portion 1554 is strengthened differently from the first strengthened portion 1552. Therefore, a second internal stress distribution of the second strengthened portion 1554 is different from a first internal stress distribution of the first strengthened portion 1552. In some embodiments, the second internal stress distribution within the second strengthened portion 1554 can provide resistance to formation of a crack due to an impact to the peripheral region. For example, the second internal stress distribution within the second strengthened portion 1554 can provide resistance to formation of a crack that extends through an exterior compressive stress region of the peripheral region 1539.

In some embodiments, an exterior compressive stress region of the second strengthened portion 1554 may contribute to the crack resistance of the second strengthened portion 1554. The second strengthened portion 1554 may therefore be referred to herein as a crack-resistant portion. In some examples, a second exterior compressive stress region of the second strengthened portion 1554 may have a greater depth of compression as compared to a first exterior compressive stress region of the first strengthened portion 1552. The second exterior compressive stress region of the second strengthened portion may also have a sufficiently high compressive stress near the exterior surface and into the second strengthened portion 1554 to retard crack formation. Examples of exterior compressive stress regions that can contribute to crack resistance of a strengthened portion within a peripheral region of a cover member are shown and described with respect to FIGS. 16B and 17B. In some embodiments, a strengthened portion similar to the strengthened portion 1554 can be combined with other crack-resistant portions previously described herein, including, but not limited to, the crack resistant portions shown and described with respect to FIGS. 2A, 4, 5, 6, 9, 10, and 12. As an example, a cover member may further include a protruding feature located in a strengthened zone that is strengthened differently from the first strengthened portion 1552. The internal stress profile in this strengthened zone may be similar to that of the strengthened portion 1554 or may be similar to that of the strengthened zone 1254 described with respect to FIG. 12.

In some embodiments, each of the first strengthened portion 1552 and the second strengthened portion 1554 is a crack-resistant portion. However, the first strengthened portion 1552 and the second strengthened portion 1554 may be strengthened differently to reflect the strengthening most beneficial to the region(s) of the cover member in which the strengthened portion is located. For example, a first compressive stress profile of the first strengthened portion 1552 may be different from a second compressive stress profile of the second strengthened portion 1554. In some embodiments, the second compressive stress profile of the second strengthened portion 1554 has a greater depth of compression that the first compressive stress profile of the first strengthened portion 1552. For example, an exterior compressive stress region may have a depth of compression that is greater than the depth of compression of an exterior compressive stress region of the first strengthened portion 1552. The additional discussion of differences in the internal stress profiles and compressive stress profiles of first and second strengthened portions provided with respect to FIGS. 16A, 16B, 17A, and 17B is generally applicable herein and not repeated here.

Alternately or additionally, the first strengthened portion 1552 and the second strengthened portion 1554 may be described in terms of ion-exchanged regions. Such a description may be useful to compare the ion-exchanged region extending from the side surface 1506 of the second strengthened portion 1554 with an ion-exchanged region extending from a surface of the first strengthened portion 1552. In some examples, the ion-exchanged regions extending from the exterior surface and the side surface 1506 of the second strengthened portion 1554 each have a depth that is greater than the depth of the ion-exchanged region extending from an exterior surface of the first strengthened portion 1552. The depth of the ion-exchanged region may be defined by the maximum depth of the ions introduced by ion exchange.

In additional embodiments, a cover member includes three strengthened portions. The three strengthened portions include a first strengthened portion that may have properties similar to the first strengthened portion 1552, a second strengthened portion that may have properties similar to the second strengthened portion 1554, and a third strengthened portion positioned between the first and the second strengthened portions. The third strengthened portion may provide a transition between the first and the second strengthened portions, such as a more gradual transition in stress-induced birefringence in the cover member. A depth of the ion-exchanged or compressive stress region in the third strengthened portion may gradually decrease from the depth of the ion-exchanged or compressive stress region in the second strengthened portion to the depth of the ion-exchanged or compressive stress region in the third strengthened portion. The third strengthened portion may have a width that is less than a width of the first strengthened portion. In some cases, the third strengthened portion may define a fourth ion-exchanged region (e.g., when the second strengthened portion is a peripheral portion of the cover member).

FIGS. 16A and 16B show examples of different compressive stress profiles in different strengthened portions of a cover member. In some cases, a first strengthened portion of the cover member has the compressive stress profile of FIG. 16A and the compressive stress profile of a second strengthened portion of the cover member has been modified to the compressive stress profile of FIG. 16B through an additional ion exchange operation.

FIG. 16A shows an example of a compressive stress profile in a first strengthened portion of a cover member. The compressive stress profile 1662 may be an example of the compressive stress profile that is located away from a peripheral region of a cover member. In some examples, the compressive stress profile 1662 may be an example of an exterior compressive stress profile in the first strengthened portion 1552 of FIG. 15. The compressive stress profile 1662 has a surface compressive stress CS_{16A}, a depth of compression DOC_{16A}, and a slope transition 1675. The slope transition 1675 is associated with a compressive stress CSK_{16A} and a depth DOK_{16A}. The compressive stress profile 1662 defines a first portion 1671 (alternately, surface portion) that extends from a surface of the cover member. The compressive stress profile 1662 also has a core portion as previously described with respect to FIGS. 3A and 3B.

FIG. 16B shows another example of a compressive stress profile in a second strengthened portion of a cover member. The compressive stress profile 1664 may be an example of a compressive stress profile that is located in a peripheral region of a cover member. In some examples, the compressive stress profile 1664 may be an example of an exterior compressive stress profile in the second strengthened portion 1554 of FIG. 15. The compressive stress profile 1664 has a surface compressive stress CS_{16B}, a depth of compression DOC_{16B}, and a slope transition 1676. The slope transition 1676 is associated with a compressive stress CSK_{16B} and a depth DOK_{16B}. The compressive stress profile 1664 defines a first portion 1672 (alternately, surface portion) that extends from a surface of the cover member. The compressive stress profile 1664 also has a core portion as previously described with respect to FIGS. 3A and 3B.

As shown in FIGS. 16A and 16B, the compressive stress profile 1664 of the second strengthened portion is different from the compressive stress profile 1662 of the first strengthened portion. Several of these differences can contribute to the greater crack-resistance provided by the compressive stress profile 1664 as compared to the compressive stress profile 1662. As an example, the greater depth of compression DOC_{16B} as compared to the depth of compression DOC_{16B} may help limit formation of a crack that extends through the compressive stress layer along the exterior surface of the cover member. As an additional example, the greater compressive stress profile integral in the surface portion 1672 of the compressive stress profile 1664 as compared to the surface portion 1671 of the compressive stress profile 1662 may also help to limit formation of a crack that extends through the compressive stress layer.

The cover member may have compressive stress layers extending from each of the exterior and the interior surfaces of the cover member, with a tensile stress region positioned between the compressive stress layers. Typically, the internal stress profile includes both compressive and tensile stress profiles. In some embodiments, the compressive stress profiles 1662 and 1664 represent compressive stress profiles of the compressive stress layer extending from the exterior surface of the cover member. In some examples, the internal stress profile is symmetric. The cover member may also have a compressive stress layer extending from a side surface of the cover member (e.g., the side surface 1506 in FIG. 15).

In some embodiments, the compressive stress profile of FIG. 16B may be obtained by forming a compressive stress profile similar to that of FIG. 16A and then performing an additional ion exchange operation. The compressive stress profile of FIG. 16A may be obtained by one or more ion-exchange operations similar to those previously described. During the additional ion-exchange operation, a portion of the cover member may be selectively exposed to an additional ion-exchange medium and/or a source of energy by methods similar to those previously described. In some embodiments, the additional ion exchange may be an operation in which potassium ions present in the ion-exchanged cover glass are replaced with sodium ions from an ion-exchange medium. The replacement of potassium ions with sodium ions can lower the surface compressive stress and the knee compressive stress, but also increase the knee depth. The replacement of potassium ions with sodium ions can also result in a lower slope of the first portion 1672 as compared to the first portion 1671. In some examples the additional ion exchange operation with sodium ions does not significantly shift the position of the maximum compressive stress in the cover member, as illustrated in the example of FIG. 16B.

FIGS. 17A and 17B show examples of different compressive stress profiles in different strengthened portions of a cover member. As previously discussed, in some embodiments one or more thermal treatment operations may be used after one or more ion exchange operations in order to produce different internal stress profiles in different strengthened portions of a cover member. The differences between the compressive stress profile of FIG. 17B and the compressive stress profile of FIG. 17A may result from a thermal treatment operation that preferentially heats a portion of the cover member to produce the compressive stress profile shown in FIG. 17B.

FIG. 17A shows an example of a compressive stress profile in a first strengthened portion of a cover member. The compressive stress profile 1762 may be an example of the compressive stress profile that is located in a region other than a peripheral region of a cover member. In some examples, the compressive stress profile 1762 may be an example of an exterior compressive stress profile in the first strengthened portion 1552 of FIG. 15. The compressive stress profile 1762 has a surface compressive stress CS_{17A}, a depth of compression DOC_{17A}, and a slope transition 1775. The slope transition 1775 is associated with a compressive stress CSK_{17A} and a depth DOK_{17A}. The compressive stress profile 1762 defines a first portion 1772 (alternately, surface portion) that extends from a surface of the cover member. The compressive stress profile 1762 also has a core portion as previously described with respect to FIGS. 3A and 3B.

FIG. 17B shows an example of a compressive stress profile in a second strengthened portion of a cover member. As previously discussed, the compressive stress profile shown in FIG. 17B may result from a thermal treatment operation that preferentially heats a portion of the cover member. The compressive stress profile 1764 may be an example of a compressive stress profile that is located in a peripheral region of a cover member. In some examples, the compressive stress profile 1764 may be an example of an exterior compressive stress profile in the second strengthened portion 1554 of FIG. 15. The compressive stress profile 1764 has a surface compressive stress CS_{17B}, a depth of compression DOC_{17B}, and a slope transition 1776. The slope transition 1776 is associated with a compressive stress CSK_{17B} and a depth DOK_{17B}. The compressive stress profile 1764 defines a first portion 1774 (alternately, surface portion) that extends from a surface of the cover member. The compressive stress profile 1764 also has a core portion as previously described with respect to FIGS. 3A and 3B.

As shown in FIGS. 17A and 17B, the compressive stress profile 1764 of the second strengthened portion is different from the compressive stress profile 1762 of the first strengthened portion. Several of these differences can contribute to the greater impact resistance provided by the compressive stress profile 1764 as compared to the compressive stress profile 1762. As an example, the greater depth of compression DOC_{17B} as compared to the depth of compression DOC_{17A} may help limit formation of a crack in response to an impact to the second portion of the cover (e.g., a crack that extends through the compressive stress layer along the exterior surface of the cover member). In some embodiments, the depth of compression after thermal treatment is at least 15%, at least 20%, at least 25%, at least 30%, from 15% to 40%, or from 20% to 35% greater than the depth of compression prior to thermal treatment and/or in a portion of the cover member that has not been exposed to the same thermal treatment. The thermal treatment may also reduce the maximum compressive stress. In some embodiments, the maximum compressive stress following thermal treatment is not more than 25% less than the maximum compressive stress prior to thermal treatment and/or in a portion of the cover member not exposed to the same thermal treatment.

When the example of FIGS. 17A and 17B is described in terms of ion-exchanged regions, the second strengthened portion may include a second ion-exchanged region that has a greater depth than a first ion-exchanged region of the first strengthened portion. Each of the first and the second ion-exchanged regions may extend from an exterior surface of the cover member and the second strengthened portion may further include a third ion-exchanged region that extends from a side surface of the cover member and that has a depth greater than the depth of the first ion-exchanged region. The first ion-exchanged region may have a first maximum sodium concentration and the second ion-exchanged region may have a second maximum sodium concentration that is less than the first maximum sodium concentration. The first ion-exchanged region may further have a first sodium concentration profile that defines a first maximum slope, and the second ion-exchanged region may have a second sodium concentration profile that defines a second maximum slope that is less than the first maximum slope. Each of the first, the second, and the third ion-exchanged regions may comprise potassium ions in addition to sodium ions.

The cover member may have compressive stress layers extending from each of the exterior and the interior surfaces of the cover member, with a tensile stress region positioned between the compressive stress layers. Typically, the internal stress profile includes both compressive and tensile stress profile. In some embodiments, the compressive stress profiles 1762 and 1764 represent compressive stress profiles of the compressive stress layer extending from the exterior surface of the cover member. In some examples, the internal stress profile is symmetric.

In some embodiments, the compressive stress profile of FIG. 17B may be obtained by forming a compressive stress profile similar to that shown in FIG. 17A and then performing a thermal treatment operation. The thermal treatment operation may preferentially cause additional diffusion of the ions that were introduced into the cover member through ion exchange. This additional diffusion of ions may increase the depth of compression and also lower the surface compressive stress.

In some embodiments, a strengthened portion of the cover member may be selectively heated to produce a desired internal stress distribution within the cover member while one or more other strengthened portions of the cover member are heated to a lesser extent. In some embodiments, a first region of the cover member is heated to a first extent and a second region of the cover member is selectively heated to a second extent that is greater than the first extent. As an example, all or part of a peripheral region of the cover member (e.g., the peripheral region 1539 of FIG. 15) may be heated to a higher temperature than one or more other regions of the cover member. In some cases, the thermal treatment may be applied to multiple surfaces of the selected region, such as an exterior, an interior, and a side surface of a peripheral region. In other cases, the thermal treatment may be applied to only one surface of the selected region, such as an exterior surface of the cover member.

In some cases, the thermal treatment operation produces a thermal gradient in a third region of the cover member that is positioned between the first and the second regions of the cover member. The thermal gradient in the third region of the cover member may produce a gradient in one or more properties of the internal stress distribution within the third region. For example, the depth of compression from the exterior surface of the cover member may gradually decrease from the depth of compression in the second region to the depth of compression in the first region of the cover member. In some cases, the thermal gradient in the third region of the cover member may provide a transition in stress-induced birefringence in the cover member.

The cover member may be selectively thermally treated by any of a variety of methods. In some embodiments, a local heating source that may be used to heat one portion of the cover while other portions of the cover are heated with another heating source that distributes heat more broadly. In some cases, the cover member may be differentially heated within a mold by using a localized and a more diffuse heating source. In other cases, the selected portion of the cover member may be locally heated using a laser or another localized heating source while other portions of the cover are heated using a more diffuse heating source. When the cover member is formed from a glass material, the glass material may be heated to a temperature below its. glass transition temperature. When a transparent cover member is formed from a glass ceramic material and the transparency of the cover member is to be retained, the glass ceramic material may be heated to a temperature low enough so that substantial crystal growth of the ceramic crystals does not occur, such a temperature less than a ceramming temperature of the glass ceramic material.

As previously discussed, in some embodiments one or more thermal treatment operations may be used prior to one or more ion exchange operations in order to produce different internal stress profiles in different strengthened portions of a cover member. FIGS. 18A and 18B show examples of different compressive stress profiles that may be obtained by using a thermal treatment operation prior to one or more ion exchange operation. The differences between the compressive stress profile of FIG. 18A and the compressive stress profile of FIG. 18B may result from a thermal treatment operation that produces a higher structural density in the portion of the cover member shown in FIG. 18B.

FIG. 18A shows an example of a compressive stress profile in a first strengthened portion of a cover member. The first portion of the cover member may have a first density prior to strengthening by ion exchange. In some examples, the cover member is a glass cover member, and the first portion of the glass cover member may have a first structural density prior to ion exchange. The compressive stress profile 1862 has a surface compressive stress CS_{18A}, a depth of compression DOC_{18A}, and a slope transition 1875. The slope transition 1875 is associated with a compressive stress CSK_{18A} and a depth DOK_{18A}. The compressive stress profile 1862 defines a first portion 1871 (alternately, surface portion) that extends from a surface of the cover member. The compressive stress profile 1862 also has a core portion as previously described with respect to FIGS. 3A and 3B.

FIG. 18B shows an example of a compressive stress profile in a second strengthened portion of a cover member. The second portion of the cover member may have a second density, greater than the first density, prior to strengthening by ion exchange. The cover member may be a glass cover member and the second portion of the glass cover member may have a second structural density prior to ion exchange that is greater than the first structural density of the first portion of the cover member. The compressive stress profile 1864 has a surface compressive stress CS_{18B}, a depth of compression DOC_{18B}, and a slope transition 1876. The slope transition 1876 is associated with a compressive stress CSK_{18B} and a depth DOK_{18B}. The compressive stress profile 1864 defines a first portion 1872 (alternately, surface portion) that extends from a surface of the cover member. The compressive stress profile 1864 also has a core portion as previously described with respect to FIGS. 3A and 3B.

As shown in FIGS. 18A and 18B, the compressive stress profile 1864 of the second strengthened portion is different from the compressive stress profile 1862 of the first strengthened portion due to differences in the structural density within the cover member prior to ion exchange. For example, the surface compressive stress CS_{18B} in the second strengthened portion is higher than the surface compressive stress CS_{18A} of the first strengthened portion, which can provide the second strengthened portion with greater resistance to bending than the first strengthened portion. The DOC_{18A} in the first strengthened portion of the cover member is greater than the depth of compression DOC_{18B} in the second strengthened portion, which can provide greater impact resistance to the first strengthened portion. The internal stress profiles of the cover member shown in FIGS. 18A and 18B typically include both compressive and tensile stress profiles. In some embodiments, the compressive stress profiles 1862 and 1864 represent compressive stress profiles of the compressive stress layer extending from the exterior surface of the cover member. In some examples, the internal stress profile is symmetric.

As previously discussed, the structural density of the second portion of the cover member prior to ion exchange is higher than the structural density of the first portion in the example of FIGS. 18A and 18B. The structural density of a given portion of a glass cover member typically relates at least in part to the compactness of a network of atoms within the glass and the spacing between the various atoms in the network. As a result of the more compact network within the second portion of the cover member, the ions introduced by an ion exchange operation may diffuse to a lesser depth in the second portion than in the first portion. Therefore, the depth of compression DOC_{18B} in the second strengthened portion may be less than the depth of compression DOC_{18A} in the first strengthened portion of the cover member. The higher structural density in the second portion of the cover member prior to ion exchange may also produce a surface compressive stress CS_{18B} that is higher than the surface compressive stress CS_{18A}.

In some embodiments, selective thermal treatment may be used to produce a greater density in one portion of a cover member than in another portion of a cover member. The selective thermal treatment may use a local heating source that heats the portion of the cover member while other portions of the cover are heated with another heating source that distributes heat more broadly. The local heating source may be any of the local heating sources previously discussed with respect to FIGS. 17A and 17B.

In some cases, the density of a portion of the cover member is modified during a process of forming a contoured cover. In these cases, pressure as well as heat may be applied during the forming process. When the cover member is formed from a glass material, the cover member may be heated to a temperature above a softening point and may heated to a working point of the glass or to any other temperature that provides the desired viscosity of the glass during the forming process. The different portions of the cover may be cooled at similar cooling rates after thermal treatment.

FIG. 19 shows an example of a contoured cover member 1940 that includes differently strengthened portions 1951 and 1952. In some embodiments, the differences in the chemical strengthening of the portions 1951 and 1952 may result at least in part from differences in the structural density of the cover member 1940 prior to ion exchange. In the example of FIG. 19, the portion 1951 is a central portion while the portion 1952 is a peripheral portion. The example of FIG. 19 is not limiting and in other examples, a peripheral portion of a cover member may have a lower structural density prior to ion exchange than a central portion.

In some embodiments, the portion 1952 is selectively heated during the process of the shaping the contoured cover in order to increase its structural density relative to that of the portion 1951. The structural density change due to selective thermal treatment may extend through a thickness of the cover member or may extend to a lesser depth from a surface of the cover member. In some cases, a structural density value within the cover member may be estimated from nearest neighbor distances, which may be determined at least in part through electron microscopy. These estimated density values may be used to compare lateral variations in the structural density within the cover member. These estimated density values may also be used to assess changes in the structural density as a function of depth within a portion of the cover member.

The contoured cover member 1940 defines a concave surface 1922 and a convex surface 1924. In some embodiments, a curvature of the concave surface 1922 and/or the convex surface 1924 in the portion 1952 is greater than a curvature of the concave surface 1922 and/or the convex surface 1924 in the portion 1951. In some examples, the concave surface 1922 may define an interior surface of the contoured cover member that is coupled to a display.

FIG. 20 shows an example block diagram of components of an electronic device. The electronic device 2000 can incorporate an enclosure having a strengthened cover as described herein. The schematic representation of FIG. 20 may correspond to components of the devices depicted in FIGS. 1A-1B, 5, 6, and 7 as described above. However, FIG. 20 may also more generally represent other types of electronic devices including an enclosure having a strengthened cover as described herein.

In embodiments, an electronic device 2000 may include a display 2002. The display 2002 may include a liquid-crystal display (LCD), a light-emitting diode (LED) display, an LED-backlit LCD display, an organic light-emitting diode (OLED) display, an active layer organic light-emitting diode (AMOLED) display, an organic electroluminescent (EL) display, an electrophoretic ink display, or the like. If the display 2002 is a liquid-crystal display or an electrophoretic ink display, the display 2002 may also include a backlight component that can be controlled to provide variable levels of display brightness. If the display 2002 is an organic light-emitting diode or an organic electroluminescent-type display, the brightness of the display 2002 may be controlled by modifying the electrical signals that are provided to display elements. In addition, information regarding configuration and/or orientation of the electronic device may be used to control the output of the display as described with respect to input devices 2012. In some cases, the display is integrated with a touch and/or force sensor in order to detect touches and/or forces applied along an exterior surface of the device 2000.

The device 2000 also includes a processor 2004. The processor 2004 may be operably connected with a computer-readable memory 2008. The processor 2004 may be operatively connected to the memory 2008 component via an electronic bus or bridge. The processor 2004 may be implemented as one or more computer processors or microcontrollers configured to perform operations in response to computer-readable instructions. The processor 2004 may include a central processing unit (CPU) of the device 2000. Additionally, and/or alternatively, the processor 2004 may include other electronic circuitry within the device 2000 including application specific integrated chips (ASIC) and other microcontroller devices. The processor 2004 may be configured to perform functionality described in the examples above.

The device 2000 also includes a power source 2006. In some embodiments, the power source includes a battery that is configured to provide electrical power to the components of the electronic device 2000. The battery may include one or more power storage cells that are linked together to provide an internal supply of electrical power. The battery may be operatively coupled to power management circuitry that is configured to provide appropriate voltage and power levels for individual components or groups of components within the electronic device 2000. The battery, via power management circuitry, may be configured to receive power from an external source, such as an alternating current power outlet. The battery may store received power so that the electronic device 2000 may operate without connection to an external power source for an extended period of time, which may range from several hours to several days.

The memory 2008 may include a variety of types of non-transitory computer-readable storage media, including, for example, read access memory (RAM), read-only memory (ROM), erasable programmable memory (e.g., EPROM and EEPROM), or flash memory. The memory 2008 is configured to store computer-readable instructions, sensor values, and other persistent software elements.

The device 2000 also includes a sensor system 2010. The sensor system 2010 may include one or more sensors or sensor components, such as a force sensor, a capacitive sensor, an accelerometer, a barometer, a gyroscope, a proximity sensor, a light sensor, a microphone, an acoustic sensor, a light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, a pulse oximeter, a biometric sensor (e.g., a fingerprint sensor), or other types of sensing device. In some cases, the device 2000 includes a sensor array (also referred to as a sensing array) which includes multiple sensors. For example, a sensor array may include an ambient light sensor, a Lidar sensor, and a microphone. In additional examples, one or more camera components may also be associated with the sensor array. The sensor system 2010 may be operably coupled to processing circuitry. In some embodiments, the sensors may detect deformation and/or changes in configuration of the electronic device and be operably coupled to processing circuitry that controls the display based on the sensor signals. In some implementations, output from the sensor system is used to reconfigure the display output to correspond to an orientation or folded/unfolded configuration or state of the device. Example sensors for this purpose include accelerometers, gyroscopes, magnetometers, and other similar types of position/orientation sensing devices.

The input/output mechanism 2012 may include one or more input devices and one or more output devices. The input device(s) are devices that are configured to receive input from a user or the environment. An input device may include, for example, a push button, a touch-activated button, a capacitive touch sensor, a touch screen (e.g., a touch-sensitive display or a force-sensitive display), a capacitive touch button, dial, crown, or the like. In some embodiments, an input device may provide a dedicated or primary function, including, for example, a power button, volume buttons, home buttons, scroll wheels, and camera buttons. The one or more output devices include the display 2002 that renders visual information, which may be generated by the processor 2004. The one or more output devices may also include one or more speakers to provide audio output and/or one or more haptic devices that are configured to produce a haptic or tactile output along an exterior surface of the device 2000. The input/output mechanism may also include a communication port or a communication channel. A communication channel may include one or more wireless interface(s) that are adapted to provide communication between the processor 2004 and an external device, one or more antennas (e.g., antennas that include or use housing components as radiating members), communications circuitry, firmware, software, or any other components or systems that facilitate wireless communications with other devices.

The electronic device 2000 also includes a system 2014 in communication with the elements 2002, 2004, 2006, 2008, 2010, and 2012. In some examples, the system 2014 includes circuitry, such as electronic buses and/or bridges. The system 2014 may also include application specific integrated chips (ASIC) and other microcontroller devices.

As used herein, use of the term “about” in reference to the endpoint of a range may signify a variation of +/−5%, +/−2%, or +/−1% of the endpoint value. In addition, disclosure of a range in which at least one endpoint is described as being “about” a specified value includes disclosure of the range in which the endpoint is equal to the specified value.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device comprising:
a display;
an optical sensor; and
a cover including a cover member comprising:
a first strengthened portion positioned over at least a portion of the display and having a first internal stress distribution;
a second strengthened portion positioned over the optical sensor and having the first internal stress distribution; and
a crack-resistant portion positioned between the first and the second strengthened portions and extending from a first region of a perimeter of the cover member to a second region of the perimeter, the crack-resistant portion having a second internal stress distribution that is different from the first internal stress distribution.

2. The electronic device of claim 1, wherein:
the second internal stress distribution has a second compressive stress value, greater than a first compressive stress value of the first internal stress distribution, at a depth from an exterior surface of the cover member;
the first strengthened portion of the cover member defines a third region of the perimeter; and
the second strengthened portion of the cover member defines a fourth region of the perimeter.

3. The electronic device of claim 2, wherein:
the cover is a front cover;
each of the first internal stress distribution and the second internal stress distribution is symmetric;
the electronic device further comprises a rear cover and a housing; and
each of the front cover and the rear cover are coupled to the housing.

4. The electronic device of claim 2, wherein:
the first internal stress distribution has a first compressive stress profile extending from the exterior surface of the cover member, the first compressive stress profile defining the first compressive stress value; and
the second internal stress distribution has a second compressive stress profile, different from the first compressive stress profile, extending from the exterior surface of the cover member, the second compressive stress profile defining the second compressive stress value.

5. The electronic device of claim 4, wherein:
the depth is a first depth;
the first compressive stress profile comprises:
a first surface portion;
a first core portion; and
a first transition between the first surface portion and the first core portion, the first transition defining the first compressive stress value at the first depth; and
the second compressive stress profile comprises:
a second surface portion;
a second core portion; and
a second transition between the second surface portion and the second core portion, the second transition at a second depth, greater than the first depth.

6. The electronic device of claim 5, wherein the cover member is formed from an aluminosilicate glass comprising lithium ions.

7. The electronic device of claim 1, wherein:
the cover member further comprises a third strengthened portion that defines a corner of the cover member;
the crack-resistant portion is a first crack-resistant portion; and
the cover member further comprises a second crack-resistant portion that is positioned between the first and the third strengthened portions of the cover member.

8. An electronic device, comprising:
a display;
a housing at least partially enclosing the display; and
a front cover coupled to the housing and including a cover member comprising:
a central portion positioned over the display and comprising a first ion-exchanged region extending from an exterior surface of the cover member, the first ion-exchanged region defining:
a first depth; and
a first compressive stress profile defining a first surface compressive stress; and
a peripheral portion comprising:
a second ion-exchanged region extending from the exterior surface of the cover member, the second ion-exchanged region having:
a second depth from the exterior surface, the second depth greater than the first depth; and
a second compressive stress profile defining a second surface compressive stress, less than the first surface compressive stress; and
a third ion-exchanged region extending from a side surface of the cover member and defining a third depth from the side surface, the third depth greater than the first depth.

9. The electronic device of claim 8, wherein:
the first ion-exchanged region comprises a first maximum sodium concentration; and
the second ion-exchanged region comprises a second maximum sodium concentration that is less than the first maximum sodium concentration.

10. The electronic device of claim 9 wherein the cover member further comprises:
a first sodium concentration profile within the first ion-exchanged region, the first sodium concentration profile defining a first maximum slope; and
a second sodium concentration profile within the second ion-exchanged region, the second sodium concentration profile defining a second maximum slope that is less than the first maximum slope.

11. The electronic device of claim 9, wherein each of the first ion-exchanged region, the second ion-exchanged region, and the third ion-exchanged region comprises potassium ions.

12. The electronic device of claim 9, wherein:
the cover member further comprises a fourth ion-exchanged region extending from the exterior surface and positioned between the first and the second ion-exchanged regions; and
a depth of the fourth ion-exchanged region gradually decreases from the second depth to the first depth.

13. The electronic device of claim 12, wherein a width of the fourth ion-exchanged region is less than a width of the first ion-exchanged region.

14. The electronic device of claim 8, wherein the cover member is formed from a glass ceramic material.

15. A mobile phone comprising:
a display;
a set of sensors;
a housing at least partially enclosing the display and the set of sensors;
a front cover coupled to the housing and positioned over the display; and
a rear cover coupled to the housing and including a rear cover member comprising:
a first region defining a first thickness and comprising a first strengthened portion of the rear cover member, the first strengthened portion including a first compressive stress region extending from an exterior surface of the rear cover member;
a second region defining a second thickness, greater than the first thickness and comprising a second strengthened portion of the rear cover member, the second strengthened portion including a second compressive stress region, different from the first compressive stress region, extending from the exterior surface of the rear cover member;
a third region extending between the first region and the second region and including a third strengthened portion of the rear cover member, the third strengthened portion including a third compressive stress region, different from the first compressive stress region, extending from the exterior surface of the rear cover member; and
a crack-resistant zone comprising the second strengthened portion and the third strengthened portions of the rear cover member.

16. The mobile phone of claim 15, wherein:
the first compressive stress region defines a first compressive stress profile that has a first profile integral; and
the second compressive stress region defines a second compressive stress profile that has a second profile integral that is greater than the first profile integral.

17. The mobile phone of claim 16, wherein:
the first compressive stress profile defines a first knee compressive stress; and
the second compressive stress profile defines a second knee compressive stress that is greater than the first knee compressive stress.

18. The mobile phone of claim 16, wherein:
the crack-resistant zone is a first crack-resistant zone; and
the rear cover member further comprises a second crack-resistant zone, different from the first crack-resistant zone and including a fourth strengthened portion defining a perimeter of the rear cover member, the fourth strengthened portion having a fourth compressive stress region extending from the exterior surface of the rear cover member and having a depth of compression that is greater than a depth of compression of the first compressive stress region.

19. The mobile phone of claim 16, wherein:
the first compressive stress region has a first average surface concentration of sodium ions and a first average surface concentration of potassium ions; and
each of the second compressive stress region and the third compressive stress region has a second average surface concentration of sodium ions that is greater than the first average surface concentration of sodium ions and a second average surface concentration of potassium ions that is less than the first average surface concentration of potassium ions.

20. The mobile phone of claim 15, wherein:
the second region of the rear cover member defines a set of openings; and
each sensor of the set of sensors extends into a respective opening of the set of openings.

21. A cover member for an electronic device, the cover member comprising:
a first strengthened portion defining at least a portion of a display window and having a first internal stress distribution;
a second strengthened portion defining a sensor window and having the first internal stress distribution; and
a crack-resistant portion extending from a first region of a perimeter of the cover member to a second region of the perimeter and positioned at least in part between the first and the second strengthened portions, the crack-resistant portion having a second internal stress distribution that is different from the first internal stress distribution.

22. The cover member of claim 21, wherein:
the first internal stress distribution of the first strengthened portion has a first depth of compression from a surface of the cover member; and
the second internal stress distribution of the crack-resistant portion has a second depth of compression, greater than the first depth of compression, from the surface of the cover member.

23. The cover member of claim 22, wherein:
the first internal stress distribution of the first strengthened portion has a first surface compressive stress; and
the second internal stress distribution of the crack-resistant portion has a second surface compressive stress that is greater than the first surface compressive stress.

24. The cover member of claim 21, wherein:
the first internal stress distribution comprises a first compressive stress profile extending from a surface of the cover member:
the first compressive stress profile defines a first compressive stress value at first transition between a first surface portion and a first core portion of the first compressive stress profile,
the second internal stress distribution comprises a second compressive stress profile extending from the surface of the cover member; and
the second compressive stress profile defines a second compressive stress value, greater than the first compressive stress value, at a second transition between a second surface portion and a second core portion of the second compressive stress profile.

25. The cover member of claim 24, wherein:
the first transition of the first compressive stress profile has a first depth from the surface; and
the second transition of the second compressive stress profile has a second depth, greater than the first depth, from the surface.
